(19) United States
(12) Patent Application Publication
(10) Pub. No.: US 2010/0173943 A1
(43) Pub. Date: Jul. 8, 2010

(54) INSECTICIDAL COMPOSITIONS WITH IMPROVED ACTION

(75) Inventors: Peter Jeschke, Bergisch Gladbach (DE); Robert Velten, Langenfeld (DE); Reiner Fischer, Monheim (DE); Rolf Pontzen, Leichlingen (DE); Udo Reckmann, Koln (DE); Erich Sanwald, Kiel (DE); Christian Arnold, Langenfeld (DE); Thomas Schenke, Bergisch Gladbach (DE); Thomas Müller, Frankfurt (DE)

Correspondence Address: STERNE, KESSLER, GOLDSTEIN & FOX P.L.L.C., 1100 NEW YORK AVENUE, N.W., WASHINGTON, DC, 20005, US

(73) Assignee: BAYER CROPSCIENCE AG, MINHEIM (DE)

(21) Appl. No.: 12/601,956

(22) PCT Filed: May 28, 2008
(86) PCT No.: PCT/EP08/04217

§ 371 Date: Nov. 25, 2009

(30) Foreign Application Priority Data
Jun. 6, 2007 (EP) 07109732.3

(51) Int. Cl. A01N 43/40; A01N 43/78; A01P 7/04

(52) U.S. Cl. 514/336; 514/357; 514/365

(57) ABSTRACT

The present invention relates to enhancement of the action of crop protection compositions comprising enaminocarbonyl compounds by the addition of ammonium salts and/or phosphonium salts or by the addition of ammonium or phosphonium salts and penetrants, to the corresponding compositions, to processes for their production and to their use in crop protection.

The present invention relates to enhancement of the action of crop protection compositions comprising enaminocarbonyl compounds by the addition of ammonium salts or phosphonium salts or by the addition of ammonium or phosphonium salts and penetrants, to the corresponding compositions, to processes for their production and to their use in crop protection.

Enaminocarbonyl compounds are known, for example, from EP 0 539 588 and WO 2006/037475. The enhancement of action for individual enaminocarbonyl compounds is described in WO 2007/068355.

Inventive enaminocarbonyl compounds are described, for example, by formula (I):

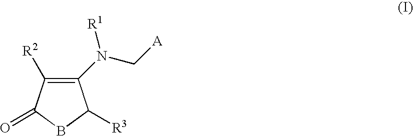

in which
A is pyrid-2-yl or pyrid-4-yl, or is pyrid-3-yl which is optionally 6-substituted by fluorine, chlorine, bromine, methyl, trifluoromethyl or trifluoromethoxy, or is pyridazin-3-yl, which is optionally 6-substituted by chlorine or methyl, or is pyrazin-3-yl or is 2-chloropyrazin-5-yl or is 1,3-thiazol-5-yl which is optionally 2-substituted by chlorine or methyl, or
A is a pyrimidyl, pyrazolyl, thiophenyl, oxazolyl, isoxazolyl, 1,2,4-oxadiazolyl, isothiazolyl, 1,2,4-triazolyl or 1,2,5-thiadiazolyl radical which is optionally substituted by fluorine, chlorine, bromine, cyano, nitro, C₁-C₄-alkyl (which is optionally substituted by fluorine and/or chlorine), C₁-C₃-alkylthio (which is optionally substituted by fluorine and/or chlorine) or C₁-C₃-alkylsulphonyl (which is optionally substituted by fluorine and/or chlorine),

or
A is a radical

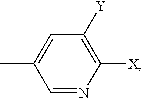

in which
X is halogen, alkyl or haloalkyl,
Y is halogen, alkyl, haloalkyl, haloalkoxy, azido or cyano,
B is oxygen, sulphur, ethylene or methylene,
R¹ is hydrogen, alkyl, haloalkyl, alkenyl, haloalkenyl, alkynyl, cycloalkyl, cycloalkylalkyl, halocycloalkyl, alkoxy or halocycloalkylalkyl,
R² is hydrogen or halogen and
R³ is hydrogen or alkyl,
with the proviso that 4-{[(6-chloropyrid-3-yl)methyl](methyl)amino}furan-2(5H)-one and 4-{[(6-chloropyrid-3-yl)methyl]amino}furan-2(5H)-one are excluded.

Preferred, particularly preferred and very particularly preferred substituents or ranges of the radicals detailed in the formula (I) mentioned above are illustrated below.

A is preferably 6-fluoropyrid-3-yl, 6-chloropyrid-3-yl, 6-bromopyrid-3-yl, 6-methylpyrid-3-yl, 6-trifluoromethylpyrid-3-yl, 6-trifluoromethoxypyrid-3-yl, 6-chloro-1,4-pyridazin-3-yl, 6-methyl-1,4-pyridazin-3-yl, 2-chloro-1,3-thiazol-5-yl or 2-methyl-1,3-thiazol-5-yl, 2-chloropyrimidin-5-yl, 2-trifluoromethylpyrimidin-5-yl, 5,6-difluoropyrid-3-yl, 5-chloro-6-fluoropyrid-3-yl, 5-bromo-6-fluoropyrid-3-yl, 5-iodo-6-fluoropyrid-3-yl, 5-fluoro-6-chloropyrid-3-yl, 5,6-dichloropyrid-3-yl, 5-bromo-6-chloropyrid-3-yl, 5-iodo-6-chloropyrid-3-yl, 5-fluoro-6-bromopyrid-3-yl, 5-chloro-6-bromopyrid-3-yl, 5,6-dibromo-pyrid-3-yl, 5-fluoro-6-iodopyrid-3-yl, 5-chloro-6-iodopyrid-3-yl, 5-bromo-6-iodopyrid-3-yl, 5-methyl-6-fluoropyrid-3-yl, 5-methyl-6-chloropyrid-3-yl, 5-methyl-6-bromopyrid-3-yl, 5-methyl-6-iodopyrid-3-yl, 5-difluoromethyl-6-fluoropyrid-3-yl, 5-difluoromethyl-6-chloropyrid-3-yl, 5-difluoromethyl-6-bromopyrid-3-yl or 5-difluoromethyl-6-iodopyrid-3-yl.
B is preferably oxygen or methylene.
R¹ is preferably optionally fluorine-substituted C₁-C₅-alkyl, C₂-C₅-alkenyl, C₃-C₅-cycloalkyl or C₃-C₅-cycloalkylalkyl.
R² is preferably hydrogen or halogen.
R³ is preferably in each case hydrogen or methyl.
A is more preferably the 6-fluoropyrid-3-yl, 6-chloropyrid-3-yl, 6-bromopyrid-3-yl, 6-chloro-1,4-pyridazin-3-yl, 2-chloro-1,3-thiazol-5-yl, 2-chloropyrimidin-5-yl, 5-fluoro-6-chloropyrid-3-yl, 5,6-dichloropyrid-3-yl, 5-bromo-6-chloropyrid-3-yl, 5-fluoro-6-bromopyrid-3-yl, 5-chloro-6-bromopyrid-3-yl, 5,6-dibromopyrid-3-yl, 5-methyl-6-chloropyrid-3-yl, 5-chloro-6-iodopyrid-3-yl or 5-difluoromethyl-6-chloropyrid-3-yl radiacl.
B is more preferably oxygen or methylene.
R¹ is more preferably methyl, ethyl, propyl, vinyl, allyl, propargyl, cyclopropyl, 2-fluoroethyl, 2,2-difluoroethyl or 2-fluorocyclopropyl.
R² is more preferably hydrogen, fluorine or chlorine.
R³ is more preferably hydrogen.
B is most preferably oxygen.
A is most preferably the 6-chloropyrid-3-yl, 6-bromopyrid-3-yl, or 6-chloro-1,4-pyridazin-3-yl, 5-fluoro-6-chloropyrid-3-yl or 5-fluoro-6-bromopyrid-3-yl radical.
R¹ is most preferably methyl, ethyl, n-propyl, n-prop-2-enyl, n-prop-2-ynyl, cyclopropyl, 2-fluoroethyl, or 2,2-difluoroethyl.
R² is most preferably hydrogen.
R³ is most preferably hydrogen.

In a prominent group of compounds of the formula (I), A is 6-fluoropyrid-3-yl

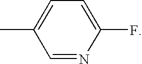

In a prominent group of compounds of the formula (I), A is 6-chloropyrid-3-yl

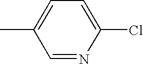

In a further prominent group of compounds of the formula (I), A is 6-bromopyrid-3-yl

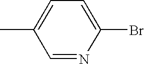

In a further prominent group of compounds of the formula (I), A is 6-trifluoromethylpyrid-3-yl

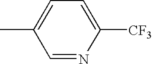

In a further prominent group of compounds of the formula (I), A is 6-chloro-1,4-pyridazin-3-yl

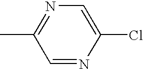

In a further prominent group of compounds of the formula (I), A is 2-chloro-1,3-thiazol-5-yl

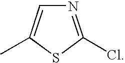

A further group of preferred compounds of the formula (I) is defined below, in which
A is pyrid-3-yl which is 6-substituted by fluorine, chlorine, bromine, methyl or trifluoromethyl, or is 2-chloropyrazin-5-yl or is 2-chloro-1,3-thiazol-5-yl,
B is oxygen, sulphur or methylene,
R¹ is halo-C₁₋₃-alkyl, halo-C₂₋₃-alkenyl, halocyclopropyl (where halogen is especially fluorine or chlorine),
R² is hydrogen or halogen,
R³ is hydrogen or methyl,
A is preferably 6-fluoropyrid-3-yl, 6-chloropyrid-3-yl, 6-bromopyrid-3-yl, 6-trifluoromethyl-pyrid-3-yl, 2-chloropyrazin-5-yl or 2-chloro-1,3-thiazol-5-yl,
B is preferably nitrogen or methylene,
R¹ is preferably difluoromethyl, 2-fluoroethyl, 2,2-difluoroethyl, 2-chloro-2-fluoroethyl, 3-fluoro-n-propyl, 2-fluorovinyl, 3,3-difluoroprop-2-enyl or 3,3-dichloroprop-2-enyl,
R² is preferably hydrogen or halogen (where halogen is especially fluorine or chlorine), R³ is preferably in each case hydrogen,
A is more preferably the 6-chloropyrid-3-yl or 6-bromopyrid-3-yl radical,
B is more preferably oxygen,
R¹ is more preferably 2-fluoroethyl or 2,2-difluoroethyl,
R² is more preferably hydrogen,
R³ is more preferably in each case hydrogen,
A is most preferably the 6-chloropyrid-3-yl or 6-bromopyrid-3-yl radical,
B is most preferably oxygen,
R¹ is most preferably 2,2-difluoroethyl,
R² is most preferably hydrogen,
R³ is most preferably in each case hydrogen,

In a further prominent group of compounds of the formula (I), R³ is hydrogen, B is oxygen and A is 6-chloropyrid-3-yl

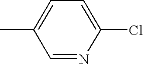

In a further prominent group of compounds of the formula (I), R³ is hydrogen, B is oxygen and A is 6-bromopyrid-3-yl

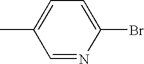

In a further prominent group of compounds of the formula (I), R³ is hydrogen, B is oxygen and A is 6-fluoropyrid-3-yl

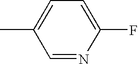

In a further prominent group of compounds of the formula (I), R³ is hydrogen, B is oxygen and A is 6-trifluoromethylpyrid-3-yl

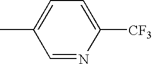

In a further prominent group of compounds of the formula (I), R³ is hydrogen, B is oxygen and A is 2-chloro-1,3-thiazol-5-yl

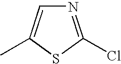

In a further prominent group of compounds of the formula (I), R² and R³ are each hydrogen, B is oxygen and A is 6-chloropyrid-3-yl

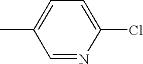

In a further prominent group of compounds of the formula (I), R² and R³ are each hydrogen, B is oxygen and A is 6-bromopyrid-3-yl

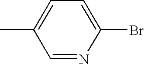

In a further prominent group of compounds of the formula (I), R² and R³ are each hydrogen, B is oxygen and A is 6-fluoropyrid-3-yl

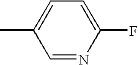

In a further prominent group of compounds of the formula (I), R² and R³ are each hydrogen, B is oxygen and A is 6-trifluoromethylpyrid-3-yl

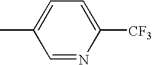

In a further prominent group of compounds of the formula (I), R² and R³ are each hydrogen, B is oxygen and A is 2-chloro-1,3-thiazol-5-yl

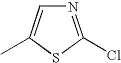

In a further prominent group of compounds of the formula (I), R² and R³ are each hydrogen, B is methylene and A is 6-chloropyrid-3-yl

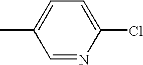

In a further prominent group of compounds of the formula (I), R² and R³ are each hydrogen, B is methylene and A is 6-bromopyrid-3-yl

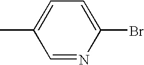

In a further prominent group of compounds of the formula (I), R² and R³ are each hydrogen, B is methylene and A is 6-fluoropyrid-3-yl

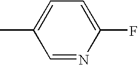

In a further prominent group of compounds of the formula (I), R² and R³ are each hydrogen, B is methylene and A is 6-trifluoromethylpyrid-3-yl

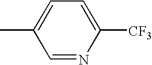

In a further prominent group of compounds of the formula (I), R² and R³ are each hydrogen, B is methylene and A is 2-chloro-1,3-thiazol-5-yl

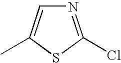

In a further prominent group of compounds of the fomula (I), R¹ is difluoromethyl, R² and R³ are each hydrogen and B is oxygen.

In a further prominent group of compounds of the formula (I), R¹ is 2-fluoroethyl, R² and R³ are each hydrogen and B is oxygen.

In a further prominent group of compounds of the formula (I), R¹ is 2,2-difluoroethyl, R² and R³ are each hydrogen and B is oxygen.

In a further prominent group of compounds of the formula (I), R¹ is difluoromethyl, R² and R³ are each hydrogen and B is methylene.

In a further prominent group of compounds of the formula (I), R¹ is 2-fluoroethyl, R² and R³ are each hydrogen and B is methylene.

In a further prominent group of compounds of the formula (I), R¹ is 2,2-difluoroethyl, R² and R³ are each hydrogen and B is methylene.

The radical definitions and illustrations listed above in general or listed in preferred ranges can be combined with one another as desired, i.e. including between the particular preferred ranges.

Preference is given in accordance with the invention to compounds of the formula (I) in which a combination of the definitions listed above as preferred is present.

Particular preference is given in accordance with the invention to compounds of the formula (I) in which a combination of the definitions listed above as particularly preferred is present.

Very particular preference is given in accordance with the invention to compounds of the formula (I) in which a combination of the definitions listed above as very particularly preferred is present.

A preferred subgroup of the inventive enaminocarbonyl compounds is that of the formula (I-a)

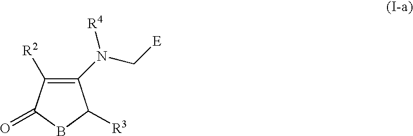

in which
E is pyrid-2-yl or pyrid-4-yl or is pyrid-3-yl which is optionally 6-substituted by fluorine, chlorine, bromine, methyl, trifluoromethyl or trifluoromethoxy, or is pyridazin-3-yl which is optionally 6-substituted by chlorine or methyl, or is pyrazin-3-yl or is 2-chloropyrazin-5-yl or is 1,3-thiazol-5-yl which is optionally 2-substituted by chlorine or methyl,
R⁴ is haloalkyl, haloalkenyl, halocycloalkyl or halocycloalkylalkyl,
and R², R³ and B are each as defined above.

Preferred substituents and ranges of the radicals listed in the formula (I-a) mentioned above and below are illustrated below.
E is preferably 6-fluoropyrid-3-yl, 6-chloropyrid-3-yl, 6-bromopyrid-3-yl, 6-methylpyrid-3-yl, 6-trifluoromethylpyrid-3-yl, 6-trifluoromethoxypyrid-3-yl, 6-chloro-1,4-pyridazin-3-yl, 6-methyl-1,4-pyridazin-3-yl, 2-chloro-1,3-thiazol-5-yl or 2-methyl-1,3-thiazol-5-yl.
B is preferably oxygen or methylene.
R² is preferably hydrogen or halogen (where halogen is especially fluorine or chlorine).
R³ is preferably in each case hydrogen or methyl.
R⁴ is preferably fluorine-substituted C₃-C₅-alkyl, C₂-C₅-alkenyl, C₃-C₅-cycloalkyl or C₃-C₅-cycloalkyalkyl.
E is more preferably the 6-fluoropyrid-3-yl, 6-chloropyrid-3-yl, 6-bromopyrid-3-yl, 6-chloro-1,4-pyridazin-3-yl, 2-chloro-1,3-thiazol-5-yl radical.
B is more preferably oxygen or methylene.
R² is more preferably hydrogen.
R³ is more preferably hydrogen.
R⁴ is more preferably 2-fluoroethyl, 2,2-difluoroethyl, 2-fluorocyclopropyl.
E is most preferably the 6-chloropyrid-3-yl, 6-bromopyrid-3-yl or 6-chloro-1,4-pyridazin-3-yl radical.
B is most preferably oxygen.
R² is most preferably hydrogen.
R³ is most preferably hydrogen.
R⁴ is most preferably 2,2-difluoroethyl.

In a prominent group of compounds of the formula (I-a), E is 6-chloropyrid-3-yl

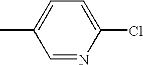

In a further prominent group of compounds of the formula (I-a), E is 6-bromopyrid-3-yl

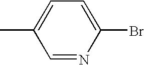

In a further prominent group of compounds of the formula (I-a), E is 6-chloro-1,4-pyridazin-3-yl

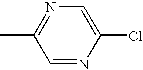

In a further prominent group of compounds of the formula (I-a), E is 2-chloro-1,3-thiazol-5-yl

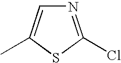

A further group of preferred compounds of the formula (I-a) is defined below, in which
E is pyrid-3-yl which is 6-substituted by fluorine, chlorine, bromine, methyl or trifluoromethyl, or is 2-chloropyrazin-5-yl or is 2-chloro-1,3-thiazol-5-yl,
B is oxygen, sulphur or methylene,
R² is hydrogen or halogen,
R³ is hydrogen or methyl,
R⁴ is halo-C₁₋₃-alkyl, halo-C₂₋₃-alkenyl, halocyclopropyl (where halogen is especially fluorine or chlorine),
E is preferably 6-fluoropyrid-3-yl, 6-chloropyrid-3-yl, 6-bromopyrid-3-yl, 6-trifluoro-methylpyrid-3-yl, 2-chloropyrazin-5-yl or 2-chloro-1,3-thiazol-5-yl,
B is preferably oxygen or methylene,
R² is preferably hydrogen or halogen (where halogen is especially fluorine or chlorine),
R³ is preferably in each case hydrogen,
R⁴ is preferably difluoromethyl, 2-fluoroethyl, 2,2-difluoroethyl, 2-chloro-2-fluoroethyl, 3-fluoro-n-propyl, 2-fluorovinyl, 3,3-difluoroprop-2-enyl or 3,3-dichloroprop-2-enyl,
E is more preferably the 6-chloropyrid-3-yl or 6-bromopyrid-3-yl radical,
B is more preferably oxygen,
R² is more preferably hydrogen,
R³ is more preferably hydrogen,
R⁴ is more preferably 2-fluoroethyl or 2,2-difluoroethyl,
E is most preferably the 6-chloropyrid-3-yl or 6-bromopyrid-3-yl radical,
B is most preferably oxygen,
R² is most preferably hydrogen,
R³ is most preferably hydrogen and
R⁴ is most preferably 2,2-difluoroethyl.

In a prominent group of compounds of the formula (I-a), R³ is hydrogen, B is oxygen and E is 6-chloropyrid-3-yl

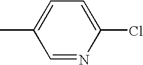

In a further prominent group of compounds of the formula (I-a), R³ is hydrogen, B is oxygen and E is 6-bromopyrid-3-yl

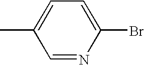

In a further prominent group of compounds of the formula (I-a), R³ is hydrogen, B is oxygen and E is 6-fluoropyrid-3-yl

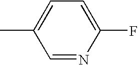

In a further prominent group of compounds of the formula (I-a), R³ is hydrogen, B is oxygen and E is 6-trifluoromethylpyrid-3-yl

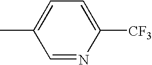

In a further prominent group of compounds of the formula (I-a), R³ is hydrogen, B is oxygen and E is 2-chloro-1,3-thiazol-5-yl

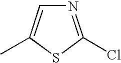

In a further prominent group of compounds of the formula (I-a), R² and R³ are each hydrogen, B is oxygen and E is 6-chloropyrid-3-yl

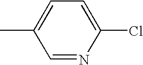

In a further prominent group of compounds of the formula (I-a), R² and R³ are each hydrogen, B is oxygen and E is 6-bromopyrid-3-yl

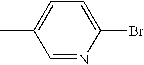

In a further prominent group of compounds of the formula (I-a), R² and R³ are each hydrogen, B is oxygen and E is 6-fluoropyrid-3-yl

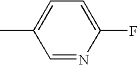

In a further prominent group of compounds of the formula (I-a), R² and R³ are each hydrogen, B is oxygen and E is 6-trifluoromethylpyrid-3-yl

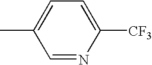

In a further prominent group of compounds of the formula (I-a), R² and R³ are each hydrogen, B is oxygen and E is 2-chloro-1,3-thiazol-5-yl

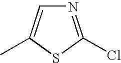

In a further prominent group of compounds of the formula (I-a), R² and R³ are each hydrogen, B is methylene and E is 6-chloropyrid-3-yl

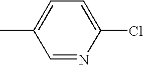

In a further prominent group of compounds of the formula (I-a), R² and R³ are each hydrogen, B is methylene and E is 6-bromopyrid-3-yl

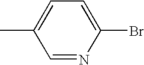

In a further prominent group of compounds of the formula (I-a), R² and R³ are each hydrogen, B is methylene and E is 6-fluoropyrid-3-yl

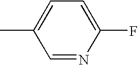

In a further prominent group of compounds of the formula (I-a), R² and R³ are each hydrogen, B is methylene and E is 6-trifluoromethylpyrid-3-yl

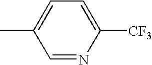

In a further prominent group of compounds of the formula (I-a), R² and R³ are each hydrogen, B is methylene and E is 2-chloro-1,3-thiazol-5-yl

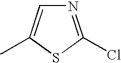

In a further prominent group of compounds of the formula (I-a), R⁴ is difluoromethyl, R² and R³ are each hydrogen and B is oxygen.

In a further prominent group of compounds of the formula (I-a), R⁴ is 2-fluoroethyl, R² and R³ are each hydrogen and B is oxygen.

In a further prominent group of compounds of the formula (I-a), R⁴ is 2,2-difluoroethyl, R² and R³ are each hydrogen and B is oxygen.

In a further prominent group of compounds of the formula (I-a), R⁴ is difluoromethyl, R² and R³ are each hydrogen and B is methylene.

In a further prominent group of compounds of the formula (I-a), R⁴ is 2-fluoroethyl, R² and R³ are each hydrogen and B is methylene.

In a further prominent group of compounds of the formula (I-a), R⁴ is 2,2-difluoroethyl, R² and R³ are each hydrogen and B is methylene.

A further preferred subgroup of inventive enaminocarbonyl compounds is that of those of the formula (I-b)

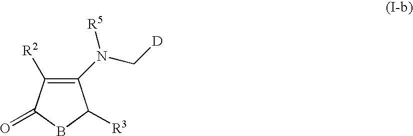

in which
D is a pyrimidinyl, pyrazolyl, thiophenyl, oxazolyl, isoxazolyl, 1,2,4-oxadiazolyl, isothiazolyl, 1,2,4-triazolyl or 1,2,5-thiadiazolyl radical which is optionally substituted by fluorine, chlorine, bromine, cyano, nitro, C₁-C₄-alkyl (which is optionally substituted by fluorine and/or chlorine), C₁-C₃-alkylthio (which is optionally substituted by fluorine and/or chlorine), or C₁-C₃-alkylsulphonyl (which is optionally substituted by fluorine and/or chlorine),

or
D is a radical

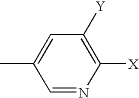

in which
X and Y are each as defined above,
R⁵ is hydrogen, alkyl, alkenyl, alkynyl, cycloalkyl or alkoxy,
and R², R³ and B are each as defined above.

Preferred substituents and ranges of the radicals detailed in the formula (I-b) mentioned above and below are illustrated hereinafter.
D is preferably 2-chloropyrimidin-5-yl or 2-trifluoromethylpyrimidin-5-yl,

in addition,
D is preferably one of the radicals 5,6-difluoropyrid-3-yl, 5-chloro-6-fluoropyrid-3-yl, 5-bromo-6-fluoropyrid-3-yl, 5-iodo-6-fluoropyrid-3-yl, 5-fluoro-6-chloropyrid-3-yl, 5,6-dichloropyrid-3-yl, 5-bromo-6-chloropyrid-3-yl, 5-iodo-6-chloropyrid-3-yl, 5-fluoro-6-bromopyrid-3-yl, 5-chloro-6-bromopyrid-3-yl, 5,6-dibromopyrid-3-yl, 5-fluoro-6-iodopyrid-3-yl, 5-chloro-6-iodopyrid-3-yl, 5-bromo-6-iodopyrid-3-yl, 5-methyl-6-fluoropyrid-3-yl, 5-methyl-6-chloropyrid-3-yl, 5-methyl-6-bromopyrid-3-yl, 5-methyl-6-iodopyrid-3-yl, 5-difluoromethyl-6-fluoropyrid-3-yl, 5-difluoromethyl-6-chloropyrid-3-yl, 5-difluoromethyl-6-bromopyrid-3-yl, 5-difluoromethyl-6-iodopyrid-3-yl.
B is preferably oxygen or methylene.
R² is preferably hydrogen or halogen (where halogen is especially fluorine or chlorine).
R³ is preferably hydrogen.
R⁵ is preferably C₁-C₄-alkyl, C₂-C₄-alkenyl, C₂-C₄-alkynyl or C₃-C₄-cycloalkyl.
D is more preferably 2-chloropyrimidin-5-yl, 5-fluoro-6-chloropyrid-3-yl, 5,6-dichloropyrid-3-yl, 5-bromo-6-chloropyrid-3-yl, 5-fluoro-6-bromopyrid-3-yl, 5-chloro-6-bromopyrid-3-yl, 5,6-dibromopyrid-3-yl, 5-methyl-6-chloropyrid-3-yl, 5-chloro-6-iodopyrid-3-yl or 5-difluoromethyl-6-chloropyrid-3-yl.
B is more preferably oxygen.
R² is more preferably hydrogen.
R³ is more preferably hydrogen.
D is most preferably 5-fluoro-6-chloropyrid-3-yl or 5-fluoro-6-bromopyrid-3-yl.
B is most preferably oxygen.
R² is most preferably hydrogen.
R³ is most preferably hydrogen.
R⁵ is most preferably methyl, ethyl, propyl, vinyl, allyl, propargyl or cyclopropyl.

In a prominent group of compounds of the formula (I-b), R³ is hydrogen, B is oxygen and D is 2-chloropyrimidin-5-yl,

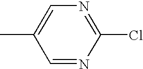

In a further prominent group of compounds of the formula (I-b), R³ is hydrogen, B is oxygen and D is 5-fluoro-6-chloropyrid-3-yl,

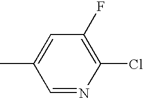

In a further prominent group of compounds of the formula (I-b), R³ is hydrogen, B is oxygen and D is 5,6-dichloropyrid-3-yl

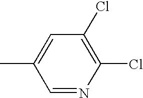

In a further prominent group of compounds of the formula (I-b), R³ is hydrogen, B is oxygen and D is 5-bromo-6-chloropyrid-3-yl

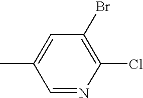

In a further prominent group of compounds of the formula (I-b), R³ is hydrogen, B is oxygen and D is 5-methyl-6-chloropyrid-3-yl

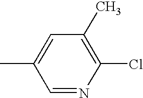

In a further prominent group of compounds of the formula (I-b), R³ is hydrogen, B is oxygen and D is 5-fluoro-6-bromopyrid-3-yl

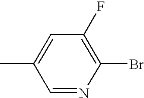

In a further prominent group of compounds of the formula (I-b), R³ is hydrogen, B is oxygen and D is 5-chloro-6-bromopyrid-3-yl

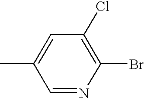

In a further prominent group of compounds of the formula (I-b), R³ is hydrogen, B is oxygen and D is 5-chloro-6-iodopyrid-3-yl

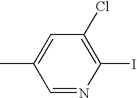

In a prominent group of compounds of the formula (I-b), R² and R³ are each hydrogen, B is oxygen and D is 2-chloropyrimidin-5-yl,

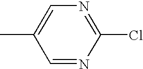

In a further prominent group of compounds of the formula (I-b), R² and R³ are each hydrogen, B is oxygen and D is 5-fluoro-6-chloropyrid-3-yl,

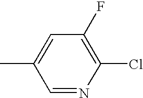

In a further prominent group of compounds of the formula (I-b), R² and R³ are each hydrogen, B is oxygen and D is 5,6-dichloropyrid-3-yl

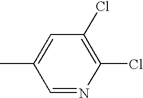

In a further prominent group of compounds of the formula (I-b), R² and R³ are each hydrogen, B is oxygen and D is 5-bromo-6-chloropyrid-3-yl

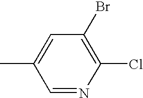

In a further prominent group of compounds of the formula (I-b), R² and R³ are each hydrogen, B is oxygen and D is 5-methyl-6-chloropyrid-3-yl

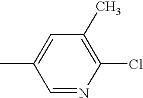

In a further prominent group of compounds of the formula (I-b), R² and R³ are each hydrogen, B is oxygen and D is 5-fluoro-6-bromopyrid-3-yl

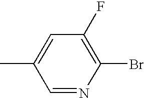

In a further prominent group of compounds of the formula (I-b), R² and R³ are each hydrogen, B is oxygen and D is 5-chloro-6-bromopyrid-3-yl

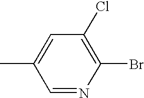

In a further prominent group of compounds of the formula (I-b), R² and R³ are each hydrogen, B is oxygen and D is 5-chloro-6-iodopyrid-3-yl

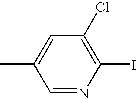

In a prominent group of compounds of the formula (I-b), R² and R³ are each hydrogen, B is methylene and D is 2-chloropyrimidin-5-yl,

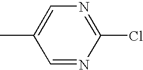

In a further prominent group of compounds of the formula (I-b), R² and R³ are each hydrogen, B is methylene and D is 5-fluoro-6-chloropyrid-3-yl,

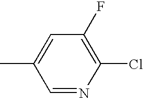

In a further prominent group of compounds of the formula (I-b), R² and R³ are each hydrogen, B is methylene and D is 5,6-dichloropyrid-3-yl

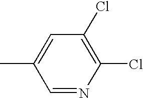

In a further prominent group of compounds of the formula (I-b), R² and R³ are each hydrogen, B is methylene and D is 5-bromo-6-chloropyrid-3-yl

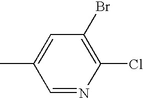

In a further prominent group of compounds of the formula (I-b), R² and R³ are each hydrogen, B is methylene and D is 5-methyl-6-chloropyrid-3-yl

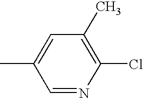

In a further prominent group of compounds of the formula (I-b), R² and R³ are each hydrogen, B is methylene and D is 5-fluoro-6-bromopyrid-3-yl

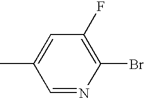

In a further prominent group of compounds of the formula (I-b), R² and R³ are each hydrogen, B is methylene and D is 5-chloro-6-bromopyrid-3-yl

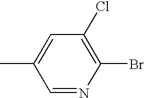

In a further prominent group of compounds of the formula (I-b), R² and R³ are each hydrogen, B is methylene and D is 5-chloro-6-iodopyrid-3-yl

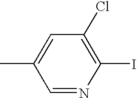

In a further prominent group of compounds of the formula (I-b), R⁵ is methyl, R² and R³ are each hydrogen and B is oxygen.

In a further prominent group of compounds of the formula (I-b), R⁵ is ethyl, R² and R³ are each hydrogen and B is oxygen.

In a further prominent group of compounds of the formula (I-b), R⁵ is cyclopropyl, R² and R³ are each hydrogen and B is oxygen.

In a further prominent group of compounds of the formula (I-b), R⁵ is methyl, R² and R³ are each hydrogen and B is methylene.

In a further prominent group of compounds of the formula (I-b), R⁵ is ethyl, R² and R³ are each hydrogen and B is methylene.

In a further prominent group of compounds of the formula (I-b), R⁵ is cyclopropyl, R² and R³ are each hydrogen and B is methylene.

A further preferred subgroup of the inventive enaminocarbonyl compounds is that of those of the formula (I-c)

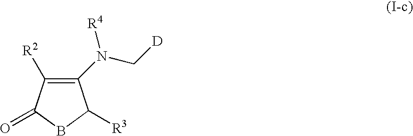

in which
D is a pyrimidinyl, pyrazolyl, thiophenyl, oxazolyl, isoxazolyl, 1,2,4-oxadiazolyl, isothiazolyl, 1,2,4-triazolyl or 1,2,5-thiadiazolyl radical which is optionally substituted by fluorine, chlorine, bromine, cyano, nitro, C₁-C₄-alkyl (which is optionally substituted by fluorine and/or chlorine), C₁-C₃-alkylthio (which is optionally substituted by fluorine and/or chlorine), or C₁-C₃-alkylsulphonyl (which is optionally substituted by fluorine and/or chlorine),

or
D is a radical

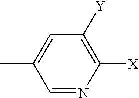

in which
X and Y are each as defined above,
R⁴ is haloalkyl, haloalkenyl, halocycloalkyl or halocycloalkylalkyl,
and R², R³ and B are each as defined above.

Preferred substituents and ranges of the radicals detailed in the formula (I-c) mentioned above and below are illustrated below.
D is preferably 2-chloropyrimidin-5-yl or 2-trifluoromethylpyrimidin-5-yl;

in addition,
D is preferably one of the radicals 5,6-difluoropyrid-3-yl, 5-chloro-6-fluoropyrid-3-yl, 5-bromo-6-fluoropyrid-3-yl, 5-iodo-6-fluoropyrid-3-yl, 5-fluoro-6-chloropyrid-3-yl, 5,6-dichloropyrid-3-yl, 5-bromo-6-chloropyrid-3-yl, 5-iodo-6-chloropyrid-3-yl, 5-fluoro-6-bromopyrid-3-yl, 5-chloro-6-bromopyrid-3-yl, 5,6-dibromopyrid-3-yl, 5-fluoro-6-iodopyrid-3-yl, 5-chloro-6-iodopyrid-3-yl, 5-bromo-6-iodopyrid-3-yl, 5-methyl-6-fluoropyrid-3-yl, 5-methyl-6-chloropyrid-3-yl, 5-methyl-6-bromopyrid-3-yl, 5-methyl-6-iodopyrid-3-yl, 5-difluoromethyl-6-fluoropyrid-3-yl, 5-difluoromethyl-6-chloropyrid-3-yl, 5-difluoromethyl-6-bromopyrid-3-yl, 5-difluoromethyl-6-iodopyrid-3-yl.
B is preferably oxygen or methylene.
R² is preferably hydrogen or halogen (where halogen is especially fluorine or chlorine).
R³ is preferably hydrogen.
R⁴ is preferably fluorine-substituted C₁-C₅-alkyl, C₂-C₅-alkenyl, C₃-C₅-cycloalkyl or C₃-C₅-cycloalkylalkyl.
D is more preferably 2-chloropyrimidin-5-yl, 5-fluoro-6-chloropyrid-3-yl, 5,6-dichloropyrid-3-yl, 5-bromo-6-chloropyrid-3-yl, 5-fluoro-6-bromopyrid-3-yl, 5-chloro-6-bromopyrid-3yl, 5,6-dibromopyrid-3-yl, 5-methyl-6-chloropyrid-3-yl, 5-chloro-6-iodopyrid-3-yl or 5-difluoromethyl-6-chloropyrid-3-yl.
B is more preferably oxygen.
R² is more preferably hydrogen.
R³ is more preferably hydrogen.
R⁴ is more preferably 2-fluoroethyl, 2,2-difluoroethyl, 2-fluorocyclopropyl.
D is most preferably 5-fluoro-6-chloropyrid-3-yl or 5-fluoro-6-bromopyrid-3-yl.
B is most preferably oxygen.
R² is most preferably hydrogen.
R³ is most preferably hydrogen.
R⁴ is most preferably 2,2-difluoroethyl.

In a prominent group of compounds of the formula (I-c), R³ is hydrogen, B is oxygen and D is 2-chloropyrimidin-5-yl,

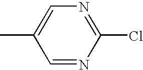

In a further prominent group of compounds of the formula (I-c), R³ is hydrogen, B is oxygen and D is 5-fluoro-6-chloropyrid-3-yl,

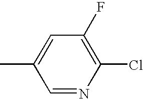

In a further prominent group of compounds of the formula (I-c), R³ is hydrogen, B is oxygen and D is 5,6-dichloropyrid-3-yl

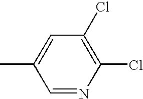

In a further prominent group of compounds of the formula (I-c), R³ is hydrogen, B is oxygen and D is 5-bromo-6-chloropyrid-3-yl

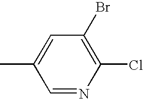

In a further prominent group of compounds of the formula (I-c), R³ is hydrogen, B is oxygen and D is 5-methyl-6-chloropyrid-3-yl

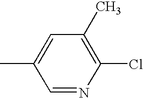

In a further prominent group of compounds of the formula (I-c), R³ is hydrogen, B is oxygen and D is 5-fluoro-6-bromopyrid-3-yl

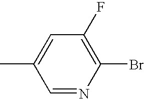

In a further prominent group of compounds of the formula (I-c), R³ is hydrogen, B is oxygen and D is 5-chloro-6-bromopyrid-3-yl

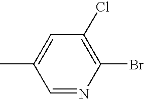

In a further prominent group of compounds of the formula (I-c), R³ is hydrogen, B is oxygen and D is 5-chloro-6-iodopyrid-3-yl

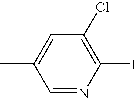

In a prominent group of compounds of the formula (I-c), R² and R³ are each hydrogen, B is oxygen and D is 2-chloropyrimidin-5-yl,

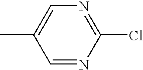

In a further prominent group of compounds of the formula (I-c), R² and R³ are each hydrogen, B is oxygen and D is 5-fluoro-6-chloropyrid-3-yl,

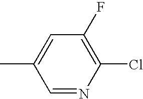

In a further prominent group of compounds of the formula (I-c), R² and R³ are each hydrogen, B is oxygen and D is 5,6-dichloropyrid-3-yl

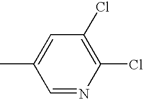

In a further prominent group of compounds of the formula (I-c), R² and R³ are each hydrogen, B is oxygen and D is 5-bromo-6-chloropyrid-3-yl

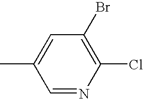

In a further prominent group of compounds of the formula (I-c), R² and R³ are each hydrogen, B is oxygen and D is 5-methyl-6-chloropyrid-3-yl

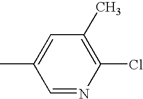

In a further prominent group of compounds of the formula (I-c), R² and R³ are each hydrogen, B is oxygen and D is 5-fluoro-6-bromopyrid-3-yl

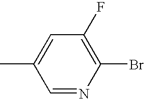

In a further prominent group of compounds of the formula (I-c), R² and R³ are each hydrogen, B is oxygen and D is 5-chloro-6-bromopyrid-3-yl

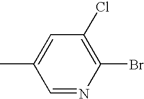

In a further prominent group of compounds of the formula (I-c), R² and R³ are each hydrogen, B is oxygen and D is 5-chloro-6-iodopyrid-3-yl

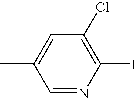

In a prominent group of compounds of the formula (I-c), R² and R³ are each hydrogen, B is methylene and D is 2-chloropyrimidin-5-yl,

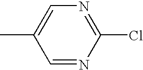

In a further prominent group of compounds of the formula (I-c), R² and R³ are each hydrogen, B is methylene and D is 5-fluoro-6-chloropyrid-3-yl,

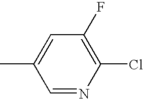

In a further prominent group of compounds of the formula (I-c), R² and R³ are each hydrogen, B is methylene and D is 5,6-dichloropyrid-3-yl

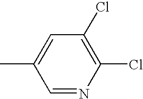

In a further prominent group of compounds of the formula (I-c), R² and R³ are each hydrogen, B is methylene and D is 5-bromo-6-chloropyrid-3-yl

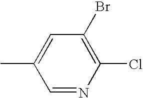

In a further prominent group of compounds of the formula (I-c), R² and R³ are each hydrogen, B is methylene and D is 5-methyl-6-chloropyrid-3-yl

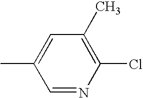

In a further prominent group of compounds of the formula (I-c), R² and R³ are each hydrogen, B is methylene and D is 5-fluoro-6-bromopyrid-3-yl

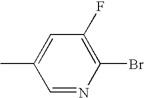

In a further prominent group of compounds of the formula (I-c), R² and R³ are each hydrogen, B is methylene and D is 5-chloro-6-bromopyrid-3-yl

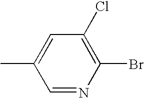

In a further prominent group of compounds of the formula (I-c), R² and R³ are each hydrogen, B is methylene and D is 5-chloro-6-iodopyrid-3-yl

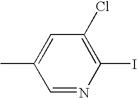

In a further prominent group of compounds of the formula (I-c), R⁴ is difluoromethyl, R² and R³ are each hydrogen and B is oxygen.

In a further prominent group of compounds of the formula (I-c), R⁴ is 2-fluoroethyl, R² and R³ are each hydrogen and B is oxygen.

In a further prominent group of compounds of the formula (I-c), R⁴ is 2,2-difluoroethyl, R² and R³ are each hydrogen and B is oxygen.

In a further prominent group of compounds of the formula (I-c), R⁴ is difluoromethyl, R² and R³ are each hydrogen and B is methylene.

In a further prominent group of compounds of the formula (I-c), R⁴ is 2-fluoroethyl, R² and R³ are each hydrogen and B is methylene.

In a further prominent group of compounds of the formula (I-c), R⁴ is 2,2-difluoroethyl, R² and R³ are each hydrogen and B is methylene.

A preferred subgroup of the inventive enaminocarbonyl compounds is that of those of the formula (I-d)

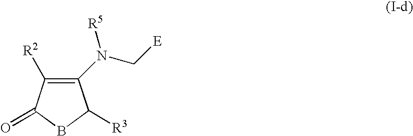

in which
E is pyrid-2-yl or pyrid-4-yl or is pyrid-3-yl which is optionally 6-substituted by fluorine, chlorine, bromine, methyl, trifluoromethyl or trifluoromethoxy, or is pyridazin-3-yl which is optionally 6-substituted by chlorine or methyl, or is pyrazin-3-yl or is 2-chloropyrazin-5-yl or is 1,3-thiazol-5-yl which is optionally 2-substituted by chlorine or methyl,
R⁵ is C₂-C₄-alkyl, alkenyl, alkynyl, cycloalkyl or alkoxy,
and R², R³ and B are each as defined above.

Preferred substituents and ranges of the radicals detailed in the formula (I-d) mentioned above and below are illustrated hereinafter.
E is preferably 6-fluoropyrid-3-yl, 6-chloropyrid-3-yl, 6-bromopyrid-3-yl, 6-methylpyrid-3-yl, 6-trifluoromethylpyrid-3-yl, 6-trifluoromethoxypyrid-3-yl, 6-chloro-1,4-pyridazin-3-yl, 6-methyl-1,4-pyridazin-3-yl, 2-chloro-1,3-thiazol-5-yl or 2-methyl-1,3-thiazol-5-yl.
B is preferably oxygen or methylene.
R² is preferably hydrogen or halogen (where halogen is especially fluorine or chlorine).
R³ is preferably in each case hydrogen or methyl.
R⁵ is preferably C₂-C₄-alkyl, C₂-C₄-alkenyl, C₂-C₄-alkynyl or C₃-C₄-cycloalkyl.
E is more preferably the 6-fluoropyrid-3-yl, 6-chloropyrid-3-yl, 6-bromopyrid-3-yl, 6-chloro-1,4-pyridazin-3-yl, 2-chloro-1,3-thiazol-5-yl radical.
B is more preferably oxygen or methylene.
R² is more preferably hydrogen.
R³ is more preferably hydrogen.
R⁵ is more preferably ethyl, propyl, vinyl, allyl, propargyl or cyclopropyl.
E is most preferably the 6-chloropyrid-3-yl, 6-bromopyrid-3-yl or 6-chloro-1,4-pyridazin-3-yl radical.
B is most preferably oxygen.
R² is most preferably hydrogen.
R³ is most preferably hydrogen.
R⁵ is most preferably ethyl or cyclopropyl.

In a prominent group of compounds of the formula (I-d), E is 6-chloropyrid-3-yl

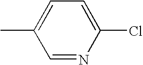

In a further prominent group of compounds of the formula (I-d), E is 6-bromopyrid-3-yl

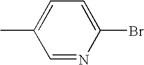

In a further prominent group of compounds of the formula (I-d), E is 6-chloro-1,4-pyridazin-3-yl

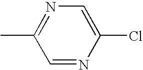

In a further prominent group of compounds of the formula (I-d), E is 2-chloro-1,3-thiazol-5-yl

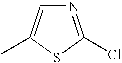

A further group of preferred compounds of the formula (I-d) is defined below, in which
E is pyrid-3-yl which is 6-substituted by fluorine, chlorine, bromine, methyl or trifluoromethyl, or is 2-chloropyrazin-5-yl or is 2-chloro-1,3-thiazol-5-yl,
B is oxygen, sulphur or methylene,
R² is hydrogen or halogen,
R³ is hydrogen or methyl,
R⁵ is C₂-C₄-alkyl, alkenyl, alkynyl, cycloalkyl or alkoxy,
E is preferably 6-fluoropyrid-3-yl, 6-chloropyrid-3-yl, 6-bromopyrid-3-yl, 6-trifluoro-methylpyrid-3-yl, 2-chloropyrazin-5-yl or 2-chloro-1,3-thiazol-5-yl,
B is preferably oxygen or methylene,
R² is preferably hydrogen or halogen (where halogen is especially fluorine or chlorine),
R³ is preferably in each case hydrogen,
R⁵ is preferably C₂-C₄-alkyl, C₂-C₄-alkenyl, C₂-C₄-alkynyl or C₃-C₄-cycloalkyl,
E is more preferably the 6-chloropyrid-3-yl or 6-bromopyrid-3-yl radical,
B is more preferably oxygen,
R² is more preferably hydrogen,
R³ is more preferably hydrogen,
R⁵ is more preferably ethyl, propyl, vinyl, allyl, propargyl or cyclopropyl,
E is most preferably the 6-chloropyrid-3-yl or 6-bromopyrid-3-yl radical,
B is most preferably oxygen,
R² is most preferably hydrogen,
R³ is most preferably hydrogen and
R⁵ is most preferably ethyl or cyclopropyl.

In a prominent group of compounds of the formula (I-d), R³ is hydrogen, B is oxygen and E is 6-chloropyrid-3-yl

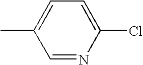

In a further prominent group of compounds of the formula (I-d), R³ is hydrogen, B is oxygen and E is 6-bromopyrid-3-yl

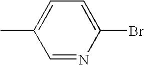

In a further prominent group of compounds of the formula (I-d), R³ is hydrogen, B is oxygen and E is 6-fluoropyrid-3-yl

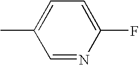

In a further prominent group of compounds of the formula (I-d), R³ is hydrogen, B is oxygen and E is 6-trifluoromethylpyrid-3-yl

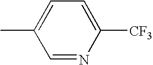

In a further prominent group of compounds of the formula (I-d), R³ is hydrogen, B is oxygen and E is 2-chloro-1,3-thiazol-5-yl

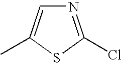

In a further prominent group of compounds of the formula (I-d), R² and R³ are each hydrogen, B is oxygen and E is 6-chloropyrid-3-yl

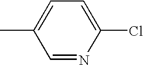

In a further prominent group of compounds of the formula (I-d), R² and R³ are each hydrogen, B is oxygen and E is 6-bromopyrid-3-yl

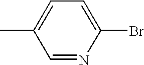

In a further prominent group of compounds of the formula (I-d), R² and R³ are each hydrogen, B is oxygen and E is 6-fluoropyrid-3-yl

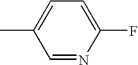

In a further prominent group of compounds of the formula (I-d), R² and R³ are each hydrogen, B is oxygen and E is 6-trifluoromethylpyrid-3-yl

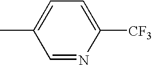

In a further prominent group of compounds of the formula (I-d), R² and R³ are each hydrogen, B is oxygen and E is 2-chloro-1,3-thiazol-5-yl

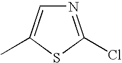

In a further prominent group of compounds of the formula (I-d), R² and R³ are each hydrogen, B is methylene and E is 6-chloropyrid-3-yl

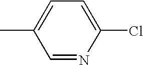

In a further prominent group of compounds of the formula (I-d), R² and R³ are each hydrogen, B is methylene and E is 6-bromopyrid-3-yl

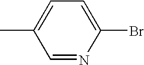

In a further prominent group of compounds of the formula (I-d), R² and R³ are each hydrogen, B is methylene and E is 6-fluoropyrid-3-yl

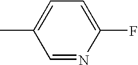

In a further prominent group of compounds of the formula (I-d), R² and R³ are each hydrogen, B is methylene and E is 6-trifluoromethylpyrid-3-yl

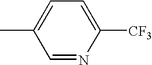

In a further prominent group of compounds of the formula (I-d), R² and R³ are each hydrogen, B is methylene and E is 2-chloro-1,3-thiazol-5-yl

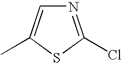

In a further prominent group of compounds of the formula (I-d), R⁵ is ethyl, R² and R³ are each hydrogen and B is oxygen.

In a further prominent group of compounds of the formula (I-d), R⁵ is cyclopropyl, R² and R³ are each hydrogen and B is oxygen.

In a further prominent group of compounds of the formula (I-d), R⁵ is ethyl, R² and R³ are each hydrogen and B is methylene.

In a further prominent group of compounds of the formula (I-d), R⁵ is cyclopropyl, R² and R³ are each hydrogen and B is methylene.

The following compounds of the general formula (I) are specified hereinafter, each of which is outstandingly suitable for the inventive uses and compositions:

### Compound (I-1), 4-{[(6-bromopyrid-3-yl)methyl](2-fluoroethyl)amino}furan-2(5H)-one, has the formula

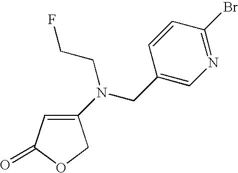

and is known from International patent application WO 2007/115644.

### Compound (I-2), 4-{([(6-bromopyrid-3-yl)methyl](2,2-difluoroethyl)amino}furan-2(5H)-one, has the formula

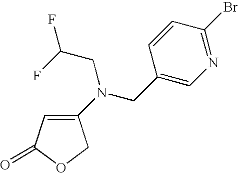

and is known from International patent application WO 2007/115644.

### Compound (I-3), 4-{[(6-fluoropyrid-3-yl)methyl](2,2-difluoroethyl)amino}furan-2(5H)-one, has the formula

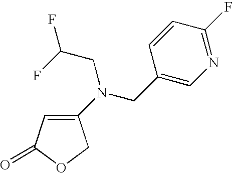

and is known from International patent application WO 2007/115644.

### Compound (I-4), 4-{[(2-chloro-1,3-thiazol-5-yl)methyl](2-fluoroethyl)amino}furan-2(5H)-one, has the formula

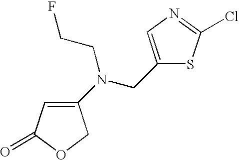

and is known from International patent application WO 2007/115644

### Compound (I-5), 3-chloro-4-{[(6-chloropyrid-3-yl)methyl](2-fluoroethyl)amino}furan-2(5H)-one, has the formula

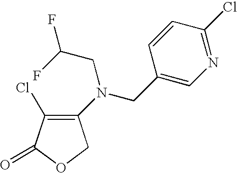

and is known from International patent application WO 2007/115644.

### Compound (I-6), 4-{[(6-chloropyrid-3-yl)methyl](2-fluoroethyl)amino}furan-2(5H)-one, has the formula

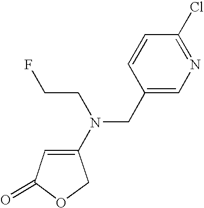

and is known from International patent application WO 2007/115644.

### Compound (I-7), 4-{[(6-chloropyrid-3-yl)methyl](2,2-difluoroethyl)amino}furan-2(5H)-one, has the formula

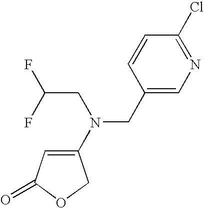

and is known from International patent application WO 2007/115644.

### Compound (I-8), 4-{[(6-chloro-5-fluoropyrid-3-yl)methyl](methyl)amino}furan-2(5H)-one, has the formula

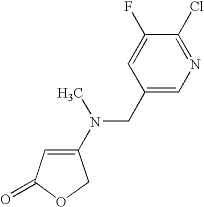

and is known from International patent application WO 2007/115643.

### Compound (I-9), 4-{[(5,6-dichloropyrid-3-yl)methyl](cyclopropyl)amino}furan-2(5H)-one, has the formula

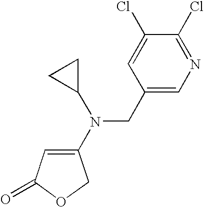

and is known from International patent application WO 2007/115643

### Compound (I-10), 4-{[(5,6-dichloropyrid-3-yl)methyl](methyl)amino}furan-2(5H)-one, has the formula

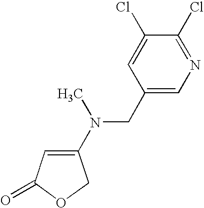

and is known from International patent application WO 2007/115643

### Compound (I-11), 4-{[(6-bromo-5-fluoropyrid-3-yl)methyl](methyl)amino}furan-2(5H)-one, has the formula

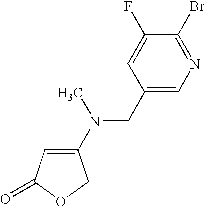

and is known from International patent application WO 2007/115643

### Compound (I-12), 4-{[(6-bromo-5-fluoropyrid-3-yl)methyl](cyclopropyl)amino}furan-2(5H)-one, has the formula

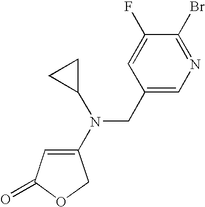

and is known from International patent application WO 2007/115643

### Compound (I-13), 4-{[(6-chloro-5-fluoropyrid-3-yl)methyl](cyclopropyl)amino}furan-2(5H)-one, has the formula

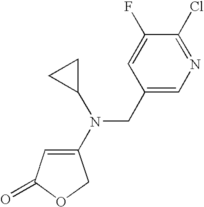

and is known from International patent application WO 2007/115643.

### Compound (I-14), 4-{[(5,6-dichloropyrid-3-yl)methyl](2-fluoroethyl)amino }furan-2(5H)-one, has the formula

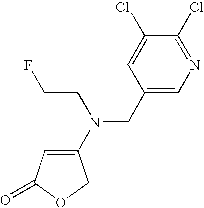

and is known from International patent application WO 2007/115646.

### Compound (I-15), 4-{[(5,6-dichloropyrid-3-yl)methyl](2-fluoroethyl)amino}furan-2(5H)-one, has the formula

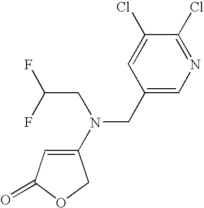

and is known from International patent application WO 2007/115646.

### Compound (I-16), 4-{[(6-bromo-5-fluoropyrid-3-yl)methyl](2,2-difluoroethyl)amino}-furan-2(5H)-one, has the formula

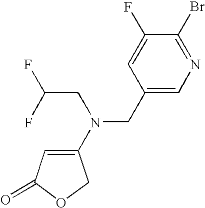

and is known from International patent application WO 2007/115646.

### Compound (I-17), 4-{[(6-chloro-5-fluoropyrid-3-yl)methyl](2,2-difluoroethyl)amino}furan-2(5H)-one, has the formula

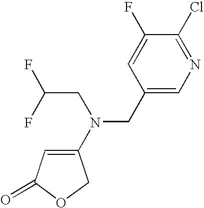

and is known from International patent application WO 2007/115646.

### Compound (I-18), 3-{[(6-chloropyrid-3-yl)methyl](methyl)amino}cyclopent-2-en-1-one, has the formula

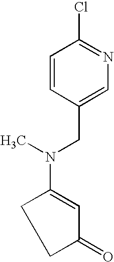

and is known from EP 0 539 588.

### Compound (I-19), 3-{[(6-chloropyrid-3-yl)methyl](cyclopropyl)amino}cyclopent-2-en-1-one, has the formula

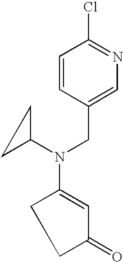

and is known from EP 0 539 588.

### Compound (I-20), 4-{[(2-chloro-2,3-dihydro-1,3-thiazol-5-yl)methyl](methyl)amino}furan-2(5H)-one, has the formula

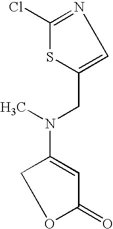

and is known from EP 0 539 588.

### Compound (I-21), 4-[methyl(pyrid-3-ylmethyl)amino]furan-2(5H)-one, has the formula

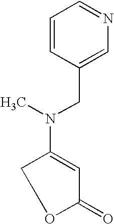

and is known from EP 0 539 588.

### Compound (I-22), 4-{cyclopropyl[(6-fluoropyrid-3-yl)methyl]amino}furan-2(5H)-one, has the formula

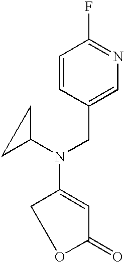

and is known from EP 0 539 588.

### Compound (I-23), 4-(methyl {[6-(trifluoromethyl)pyrid-3-yl]methyl}amino)furan-2(5H)-one, has the formula

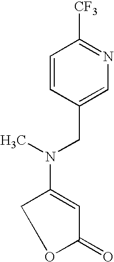

and is known from EP 0 539 588.

### Compound (I-24), 4-(cyclopropyl {[6-(trifluoromethyl)pyrid-3-yl]methyl}amino)furan-2(5H)-one, has the formula

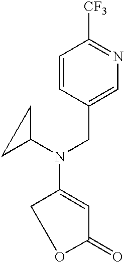

and is known from EP 0 539 588.

### Compound (I-25), 4-{[(6-chloropyrid-3-yl)methyl](methyl)amino}-5-methylfuran-2(5H)-one, has the formula

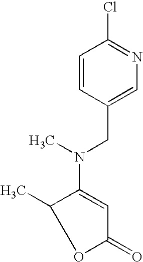

and is known from EP 0 539 588.

### Compound (I-26), 4-{[(6-bromopyrid-3-yl)methyl](methyl)amino}furan-2(5H)-one, has the formula

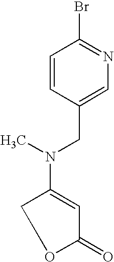

and is known from EP 0 539 588.

### Compound (I-27), 4-{[(6-chloropyrid-3-yl)methyl](methyl)amino}thiophen-2(5H)-one, has the formula

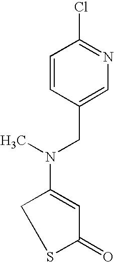

and is known from EP 0 539 588.

### Compound (I-28), 4-{[(6-chloropyrid-3-yl)methyl](methyl)amino}-3-fluorofuran-2(5H)-one, has the formula

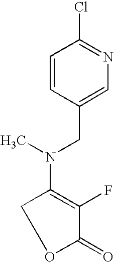

and is known from EP 0 539 588.

### Compound (I-29), 4-{[(6-chloropyrid-3-yl)methyl](methoxy)amino}furan-2(5H)-one, has the formula

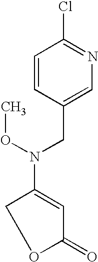

and is known from EP 0 539 588.

### Compound (I-30), 4-{[(6-chloropyrid-3-yl)methyl](ethyl)amino}furan-2(5H)-one, has formula

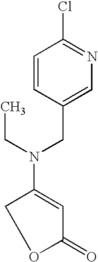

and is known from EP 0 539 588.

### Compound (I-31), 4-{[(6-chloropyrid-3-yl)methyl](cyclopropyl)amino}furan-2(5H)-one, has the formula

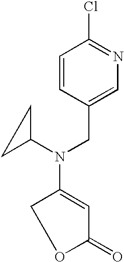

and is known from EP 0 539 588.

### Compound (I-32), 4-{allyl[(6-chloropyrid-3-yl)methyl]amino}furan-2(5H)-one, has the formula

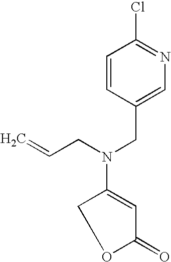

and is known from EP 0 539 588.

### Compound (I-33), 4-{[(6-chloropyrid-3-yl)methyl](prop-2-yn-1-yl)amino}furan-2(5H)-one, has the formula

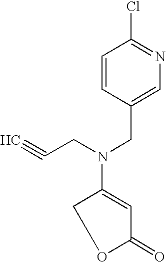

and is known from EP 0 539 588.

### Compound (I-34), 3-{[(6-chloropyrid-3-yl)methyl](propyl)amino}cyclohex-2-en-1-one, has the formula

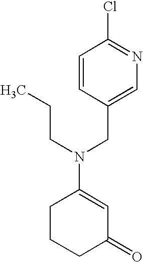

and is known from EP 0 539 588.

### Compound (I-35), 3-{allyl[(6-chloropyrid-3-yl)methyl]amino}cyclohex-2-en-1-one, has the formula

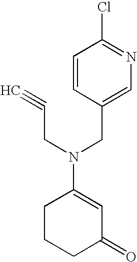

and is known from EP 0 539 588.

### Compound (I-36), 3-{[(6-chloropyrid-3-yl)methyl](prop-2-yn-1-yl)amino}cyclohex-2-en-1-one, has the formula

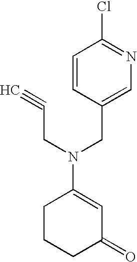

and is known from EP 0 539 588.

### Compound (I-37), 3-{[(6-chloropyrid-3-yl)methyl]amino}cyclohex-2-en-1-one, has the formula

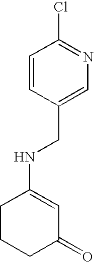

and is known from EP 0 539 588.

### Compound (I-38), 3-{[(6-chloropyrid-3-yl)methyl](methyl)amino}cyclohex-2-en-1-one, has the formula

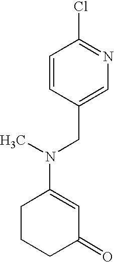

and is known from EP 0 539 588.

### Compound (I-39), 3-{[(6-chloropyrid-3-yl)methyl](ethyl)amino}cyclohex-2-en-1-one, has the formula

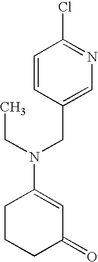

and is known from EP 0 539 588.

Halogen-substituted radicals, e.g. haloalkyl, are mono- or polyhalogenated up to the maximum possible number of substituents. In the case of polyhalogenation, the halogen atoms may be the same or different. Halogen is fluorine, chlorine, bromine or iodine, especially fluorine, chlorine or bromine.

Preference, particular preference or very particular preference is given to compounds which in each case bear the substituents specified under preferred, particularly preferred or very particularly preferred.

Saturated or unsaturated hydrocarbon radicals such as alkyl or alkenyl may, also in conjunction with heteroatoms, for example in alkoxy, where possible, each be straight-chain or branched.

Optionally substituted radicals may be mono- or polysubstituted, where the substituents may be the same or different in the case of polysubstitutions.

The radical definitions and illustrations listed above in general terms or listed in preferred ranges can, however, also be combined with one another as desired, i.e. between the particular ranges and preferred ranges.

The active ingredients can be used in the inventive compositions within a wide concentration range. The concentration of the active ingredients in the formulation is typically 0.1-50% by weight.

In the literature, it has already been stated that the action of different active ingredients can be enhanced by adding ammonium or phosphonium salts. However, these are salts which act as a detergent (e.g. WO 95/017817) or salts with relatively long alkyl and/or aryl substituents which have permeabilizing action or increase the solubility of the active ingredient (for example

EP-A 0 453 086, EP-A 0 664 081, FR-A 2 600 494, U.S. Pat. No. 4,844,734, U.S. Pat. No. 5,462,912, U.S. Pat. No. 5,538,937, U.S. Pat. No. 03/0,224,939, U.S. Pat. No. 05/0,009,880, U.S. Pat. No. 05/0,096,386). In addition, the prior art describes the effect only for particular active ingredients and/or particular uses of the corresponding compositions. In other cases again, the salts are those of sulphonic acids in which the acids themselves have paralysing action on insects (U.S. Pat. No. 2,842,476). An enhancement of action by ammonium sulphate has been described for the herbicides glyphosate and phosphinothricin (U.S. Pat. No. 6,645,914, EP-A 0 036 106). A corresponding effect in the case of the inventive insecticides is neither disclosed nor suggested by this prior art.

The use of ammonium sulphate as a formulating assistant has also been described for particular active ingredients and uses (WO 92/16108), but it serves there to stabilize the formulation, not to enhance the action.

It has now been found that, completely surprisingly, the action of insecticidal enaminocarbonyl compounds can be enhanced significantly through the addition of ammonium and/or phosphonium salts to the use solution (tankmix application) or through the incorporation of these salts into a formulation comprising such insecticides. The present invention thus provides for the use of ammonium and/or phosphonium salts for enhancing the action of crop protection compositions which comprise insecticidally active enaminocarbonyl compounds. The invention likewise provides compositions which comprise such insecticides and action-enhancing ammonium and/or phosphonium salts, specifically both formulated active ingredients and ready-to-use compositions (spray liquors). The invention finally further provides for the use of these compositions for controlling harmful insects.

Ammonium and phosphonium salts which, in accordance with the invention, enhance the action of crop protection compositions comprising enaminocarbonyl compounds are defined by formula (II)

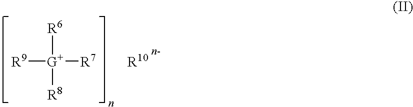

in which
G is nitrogen or phosphorus,
G is preferably nitrogen,
R⁶, R⁷, R⁸ and R⁹ are each independently hydrogen or in each case optionally substituted C₁-C₈-alkyl or mono- or polyunsaturated, optionally substituted C₂-C₈-alkylene, where the substituents may be selected from halogen, nitro and cyano,
R⁶, R⁷, R⁸ and R⁹ are preferably each independently hydrogen or in each case optionally substituted C₁-C₄-alkyl, where the substituents may be selected from halogen, nitro and cyano,
R⁶, R⁷, R⁸ and R⁹ are more preferably each independently hydrogen methyl, ethyl, n-propyl, i-propyl, n-butyl, i-butyl, s-butyl or t-butyl,
R⁶, R⁷, R⁸ and R⁹ are most preferably each hydrogen,
R⁶, R⁷, R⁸ and R⁹ are additionally most preferably simultaneously methyl or simultaneously ethyl,
n is 1, 2, 3 or 4,
n is preferably 1 or 2,
R¹⁰ is an inorganic or organic anion,
R¹⁰ is preferably hydrogencarbonate, tetraborate, fluoride, bromide, iodide, chloride, monohydrogenphosphate, dihydrogenphosphate, hydrogensulphate, tartrate, sulphate, nitrate, thiosulphate, thiocyanate, formate, lactate, acetate, propionate, butyrate, pentanoate, citrate, oxalate, carbonate, pentaborate, sulphite, benzoate, hydrogenoxalate, hydrogencitrate, methylsulphate or tetrafluoroborate,
R¹⁰ is more preferably lactate, sulphate, nitrate, thiosulphate, thiocyanate, citrate, oxalate, formate, monohydrogenphosphate or dihydrogenphosphate, and
R¹⁰ is most preferably sulphate.

The ammonium and phosphonium salts of the formula (II) can be used within a wide concentration range to enhance the action of crop protection compositions comprising enaminocarbonyl compounds. In general, the ammonium or phosphonium salts are used in a ready-to-use crop protection composition in a concentration of 0.5 to 80 mmol/1, preferably 0.75 to 37.5 mmol/1, more preferably 1.5 to 25 mmol/1. In the case of a formulated product, the ammonium and/or phosphonium salt concentration in the formulation is selected such that, after dilution of the formulation to the desired active ingredient concentration, it is within these stated general, preferred or particularly preferred ranges. The concentration of the salt in the formulation is typically 1-50% by weight.

In a preferred embodiment of the invention, not only an ammonium and/or phosphonium salt but additionally a penetrant is added to the crop protection compositions to enhance the action. It can be described as completely surprising that, even in these cases, an even greater enhancement of action is observed. The present invention thus likewise provides for the use of a combination of penetrant and ammonium and/or phosphonium salts for enhancing the action of crop protection compositions which comprise insecticidally active enaminocarbonyl compounds as an active ingredient. The invention likewise provides compositions which comprise insecticidally active enaminocarbonyl compounds, penetrants and ammonium and/or phosphonium salts, both in the form of formulated active ingredients and of ready-to-use compositions (spray liquors). The invention finally further provides for the use of these compositions for controlling harmful insects.

Useful penetrants in the present context include all of those substances which are typically used in order to improve the penetration of active agrochemical ingredients into plants. In this connection, penetrants are defined such that they penetrate from the aqueous spray liquor and/or from the sprayed coating into the cuticle of the plant and thus increase the mobility of active ingredients in the cuticle. The method described in the literature (Baur et al., 1997, Pesticide Science 51, 131-152) can be used to determine this property.

Useful penetrants include, for example, alkanol alkoxylates. Inventive penetrants are alkanol alkoxylates of the formula

R—O—(-AO)ᵥ—R′ (III)

in which
R is straight-chain or branched alkyl having from 4 to 20 carbon atoms,
R^{′} is hydrogen, methyl, ethyl, n-propyl, i-propyl, n-butyl, i-butyl, t-butyl, n-pentyl or n-hexyl,
AO is an ethylene oxide radical, a propylene oxide radical, a butylene oxide radical, or mixtures of ethylene oxide and propylene oxide radicals or butylene oxide radicals, and
v is 2 to 30.

A preferred group of penetrants is that of alkanol alkoxylates of the formula

R—O—(-EO—)ₘ—R′ (III-a)

in which
R is as defined above,
R′ is as defined above,
EO is —CH₂—CH₂—O— and
m is 2 to 20.

A further preferred group of penetrants is that of alkanol alkoxylates of the formula

R—O—(-EO—)ₚ—(—PO—)_{q}—R′ (III-b)

in which
R is as defined above,
R′ is as defined above,
EO is —CH₂—CH₂—O—,
PO is

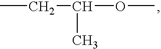

p is 1 to 10 and
q is 1 to 10.

A further preferred group of penetrants is that of alkanol alkoxylates of the formula

R—O—(—PO—)ᵣ—(EO—)ₛ—R′ (III-c)

in which
R is as defined above,
R′ is as defined above,
EO is —CH₂—CH₂—O—,
PO is

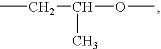

r is 1 to 10 and
s is 1 to 10.

A further preferred group of penetrants is that of alkanol alkoxylates of the formula

R—O—(-EO—)ᵥ—(—BO—)ₓ—R′ (III-d)

in which
R and R′ are each as defined above,
EO is CH₂—CH₂—O—,
BO is

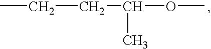

v is 1 to 10 and
x is 1 to 10.

A further preferred group of penetrants is that of alkanol alkoxylates of the formula

R—O—(—BO—)_{y}—(-EO—)_{z}—R′ (III-e)

in which
R and R′ are each as defined above,
BO is

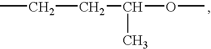

EO is CH₂—CH₂—O—,
y is 1 to 10 and
z is 1 to 10.

A further preferred group of penetrants is that of alkanol alkoxylates of the formula

CH₃—(CH₂)ₜ—CH₂—O—(—CH₂—CH₂—O—)ᵤ—R′ (III-f)

in which
R′ is as defined above,
t is 8 to 13,
u is 6 to 17.

In the above-specified formulae,

R is preferably butyl, i-butyl, n-pentyl, i-pentyl, neopentyl, n-hexyl, i-hexyl, n-octyl, i-octyl, 2-ethylhexyl, nonyl, i-nonyl, decyl, n-dodecyl, i-dodecyl, lauryl, myristyl, i-tridecyl, trimethylnonyl, palmityl, stearyl or eicosyl.

One example of an alkanol alkoxylate of the formula (III-c) is 2-ethylhexyl alkoxylate of the formula

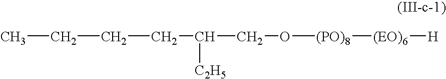

in which
EO is —CH₂—CH₂—O—,

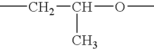

and

the numbers 8 and 6 are average values.

One example of an alkanol alkoxylate of the formula (III-d) is the formula

CH₃—(CH₂)₁₀—O—(-EO—)₆—BO—)₂—CH₃ (III-d-1)

in which
EO is CH₂—CH₂—O—,

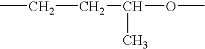

and

the numbers 10, 6 and 2 are average values.

Particularly preferred alkanol alkoxylates of the formula (III-f) are compounds of this formula in which
t is 9 to 12 and
u is 7 to 9.

Very particular preference is given to alkanol alkoxylate of the formula (III-f-1)

CH₃—(CH₂)ₜ—CH₂—O—(—CH₂—CH₂—O—)ᵤ—H (III-f-1)

in which
t is the average value of 10.5 and
u is the average value of 8.4.

The alkanol alkoxylates are defined in general by the above formulae. These substances are mixtures of substances of the type specified with different chain lengths. For the indices, average values which may also deviate from integer values are therefore calculated.

The alkanol alkoxylates of the formulae specified are known, and some of them are commercially available or can be prepared by known methods (cf. WO 98-35 553, WO 00-35 278 and EP-A 0 681 865).

Useful penetrants are, for example, also substances which promote the solubility of the compounds of the formula (I) in the spray covering. These include, for example, mineral or vegetable oils. Useful oils include all mineral or vegetable oils, optionally modified, which are typically useable in agrochemical compositions. Examples include sunflower oil, rapeseed oil, olive oil, castor oil, colza oil, maize kernel oil, cottonseed oil, and soybean oil, or the esters of the oils mentioned. Preference is given to rapeseed oil, sunflower oil, and their methyl or ethyl esters. Particular preference is given to rapeseed oil methyl ester.

The concentration of penetrants in the inventive compositions can vary within a wide range. In the case of a formulated crop protection composition, it is generally 1 to 95% by weight, preferably 1 to 55% by weight, more preferably 15-40% by weight. In the ready-to-use compositions (spray liquors), the concentration is generally between 0.1 and 10 g/l, preferably between 0.5 and 5 g/l.

Combinations of active ingredient, salt and penetrant which are prominent in accordance with the invention are listed in the table which follows, each individual combination being prominent on its own. “According to test” means that any compound which acts as a penetrant in the test for cuticle penetration is suitable (Baur et al., 1997, Pesticide Science 51, 131-152).

| Number | Active ingredient | Salt | Penetrant |
|---|---|---|---|
| 1 | (I-1) | Ammonium sulphate | According to test |
| 2 | (I-1) | Ammonium lactate | According to test |
| 3 | (I-1) | Ammonium nitrate | According to test |
| 4 | (I-1) | Ammonium thiosulphate | According to test |
| 5 | (I-1) | Ammonium thiocyanate | According to test |
| 6 | (I-1) | Ammonium citrate | According to test |
| 7 | (I-1) | Ammonium oxalate | According to test |
| 8 | (I-1) | Ammonium formate | According to test |
| 9 | (I-1) | Ammonium hydrogenphosphate | According to test |
| 10 | (I-1) | Ammonium dihydrogenphosphate | According to test |
| 11 | (I-1) | Ammonium carbonate | According to test |
| 12 | (I-1) | Ammonium sulphite | According to test |
| 13 | (I-1) | Ammonium benzoate | According to test |
| 14 | (I-1) | Ammonium hydrogenoxalate | According to test |
| 15 | (I-1) | Ammonium hydrogencitrate | According to test |
| 16 | (I-1) | Ammonium acetate | According to test |
| 17 | (I-1) | Tetramethylammonium sulphate | According to test |
| 18 | (I-1) | Tetramethylammonium lactate | According to test |
| 19 | (I-1) | Tetramethylammonium nitrate | According to test |
| 20 | (I-1) | Tetramethylammonium thiosulphate | According to test |
| 21 | (I-1) | Tetramethylammonium thiocyanate | According to test |
| 22 | (I-1) | Tetramethylammonium citrate | According to test |
| 23 | (I-1) | Tetramethylammonium oxalate | According to test |
| 24 | (I-1) | Tetramethylammonium formate | According to test |
| 25 | (I-1) | Tetramethylammonium hydrogenphosphate | According to test |
| 26 | (I-1) | Tetramethylammonium dihydrogenphosphate | According to test |
| 27 | (I-1) | Tetraethylammonium sulphate | According to test |
| 28 | (I-1) | Tetraethylammonium lactate | According to test |
| 29 | (I-1) | Tetraethylammonium nitrate | According to test |
| 30 | (I-1) | Tetraethylammonium thiosulphate | According to test |
| 31 | (I-1) | Tetraethylammonium thiocyanate | According to test |
| 32 | (I-1) | Tetraethylammonium citrate | According to test |
| 33 | (I-1) | Tetraethylammonium oxalate | According to test |
| 34 | (I-1) | Tetraethylammonium formate | According to test |
| 35 | (I-1) | Tetraethylammonium hydrogenphosphate | According to test |
| 36 | (I-1) | Tetraethylammonium dihydrogenphosphate | According to test |
| 37 | (I-2) | Ammonium sulphate | According to test |
| 38 | (I-2) | Ammonium lactate | According to test |
| 39 | (I-2) | Ammonium nitrate | According to test |
| 40 | (I-2) | Ammonium thiosulphate | According to test |
| 41 | (I-2) | Ammonium thiocyanate | According to test |
| 42 | (I-2) | Ammonium citrate | According to test |
| 43 | (I-2) | Ammonium oxalate | According to test |
| 44 | (I-2) | Ammonium formate | According to test |
| 45 | (I-2) | Ammonium hydrogenphosphate | According to test |
| 46 | (I-2) | Ammonium dihydrogenphosphate | According to test |
| 47 | (I-2) | Ammonium carbonate | According to test |
| 48 | (I-2) | Ammonium sulphite | According to test |
| 49 | (I-2) | Ammonium benzoate | According to test |
| 50 | (I-2) | Ammonium hydrogenoxalate | According to test |
| 51 | (I-2) | Ammonium hydrogencitrate | According to test |
| 52 | (I-2) | Ammonium acetate | According to test |
| 53 | (I-2) | Tetramethylammonium sulphate | According to test |
| 54 | (I-2) | Tetramethylammonium lactate | According to test |
| 55 | (I-2) | Tetramethylammonium nitrate | According to test |
| 56 | (I-2) | Tetramethylammonium thiosulphate | According to test |
| 57 | (I-2) | Tetramethylammonium thiocyanate | According to test |
| 58 | (I-2) | Tetramethylammonium citrate | According to test |
| 59 | (I-2) | Tetramethylammonium oxalate | According to test |
| 60 | (I-2) | Tetramethylammonium formate | According to test |
| 61 | (I-2) | Tetramethylammonium hydrogenphosphate | According to test |
| 62 | (I-2) | Tetramethylammonium dihydrogenphosphate | According to test |
| 63 | (I-2) | TetraethylAmmonium sulphate | According to test |
| 64 | (I-2) | Tetraethylammonium lactate | According to test |
| 65 | (I-2) | Tetraethylammonium nitrate | According to test |
| 66 | (I-2) | Tetraethylammonium thiosulphate | According to test |
| 67 | (I-2) | Tetraethylammonium thiocyanate | According to test |
| 68 | (I-2) | Tetraethylammonium citrate | According to test |
| 69 | (I-2) | Tetraethylammonium oxalate | According to test |
| 70 | (I-2) | Tetraethylammonium formate | According to test |
| 71 | (I-2) | Tetraethylammonium hydrogenphosphate | According to test |
| 72 | (I-2) | Tetraethylammonium dihydrogenphosphate | According to test |
| 73 | (I-3) | Ammonium sulphate | According to test |
| 74 | (I-3) | Ammonium lactate | According to test |
| 75 | (I-3) | Ammonium nitrate | According to test |
| 76 | (I-3) | Ammonium thiosulphate | According to test |
| 77 | (I-3) | Ammonium thiocyanate | According to test |
| 78 | (I-3) | Ammonium citrate | According to test |
| 79 | (I-3) | Ammonium oxalate | According to test |
| 80 | (I-3) | Ammonium formate | According to test |
| 81 | (I-3) | Ammonium hydrogenphosphate | According to test |
| 82 | (I-3) | Ammonium dihydrogenphosphate | According to test |
| 83 | (I-3) | Ammonium carbonate | According to test |
| 84 | (I-3) | Ammonium sulphite | According to test |
| 85 | (I-3) | Ammonium benzoate | According to test |
| 86 | (I-3) | Ammonium hydrogenoxalate | According to test |
| 87 | (I-3) | Ammonium hydrogencitrate | According to test |
| 88 | (I-3) | Ammonium acetate | According to test |
| 89 | (I-3) | Tetramethylammonium sulphate | According to test |
| 90 | (I-3) | Tetramethylammonium lactate | According to test |
| 91 | (I-3) | Tetramethylammonium nitrate | According to test |
| 92 | (I-3) | Tetramethylammonium thiosulphate | According to test |
| 93 | (I-3) | Tetramethylammonium thiocyanate | According to test |
| 94 | (I-3) | Tetramethylammonium citrate | According to test |
| 95 | (I-3) | Tetramethylammonium oxalate | According to test |
| 96 | (I-3) | Tetramethylammonium formate | According to test |
| 97 | (I-3) | Tetramethylammonium hydrogenphosphate | According to test |
| 98 | (I-3) | Tetramethylammonium dihydrogenphosphate | According to test |
| 99 | (I-3) | Tetraethylammonium sulphate | According to test |
| 100 | (I-3) | Tetraethylammonium lactate | According to test |
| 101 | (I-3) | Tetraethylammonium nitrate | According to test |
| 102 | (I-3) | Tetraethylammonium thiosulphate | According to test |
| 103 | (I-3) | Tetraethylammonium thiocyanate | According to test |
| 104 | (I-3) | Tetraethylammonium citrate | According to test |
| 105 | (I-3) | Tetraethylammonium oxalate | According to test |
| 106 | (I-3) | Tetraethylammonium formate | According to test |
| 107 | (I-3) | Tetraethylammonium hydrogenphosphate | According to test |
| 108 | (I-3) | Tetraethylammonium dihydrogenphosphate | According to test |
| 109 | (I-4) | Ammonium sulphate | According to test |
| 110 | (I-4) | Ammonium lactate | According to test |
| 111 | (I-4) | Ammonium nitrate | According to test |
| 112 | (I-4) | Ammonium thiosulphate | According to test |
| 113 | (I-4) | Ammonium thiocyanate | According to test |
| 114 | (I-4) | Ammonium citrate | According to test |
| 115 | (I-4) | Ammonium oxalate | According to test |
| 116 | (I-4) | Ammonium formate | According to test |
| 117 | (I-4) | Ammonium hydrogenphosphate | According to test |
| 118 | (I-4) | Ammonium dihydrogenphosphate | According to test |
| 119 | (I-4) | Ammonium carbonate | According to test |
| 120 | (I-4) | Ammonium sulphite | According to test |
| 121 | (I-4) | Ammonium benzoate | According to test |
| 122 | (I-4) | Ammonium hydrogenoxalate | According to test |
| 123 | (I-4) | Ammonium hydrogencitrate | According to test |
| 124 | (I-4) | Ammonium acetate | According to test |
| 125 | (I-4) | Tetramethylammonium sulphate | According to test |
| 126 | (I-4) | Tetramethylammonium lactate | According to test |
| 127 | (I-4) | Tetramethylammonium nitrate | According to test |
| 128 | (I-4) | Tetramethylammonium thiosulphate | According to test |
| 129 | (I-4) | Tetramethylammonium thiocyanate | According to test |
| 130 | (I-4) | Tetramethylammonium citrate | According to test |
| 131 | (I-4) | Tetramethylammonium oxalate | According to test |
| 132 | (I-4) | Tetramethylammonium formate | According to test |
| 133 | (I-4) | Tetramethylammonium hydrogenphosphate | According to test |
| 134 | (I-4) | Tetramethylammonium dihydrogenphosphate | According to test |
| 135 | (I-4) | Tetraethylammonium sulphate | According to test |
| 136 | (I-4) | Tetraethylammonium lactate | According to test |
| 137 | (I-4) | Tetraethylammonium nitrate | According to test |
| 138 | (I-4) | Tetraethylammonium thiosulphate | According to test |
| 139 | (I-4) | Tetraethylammonium thiocyanate | According to test |
| 140 | (I-4) | Tetraethylammonium citrate | According to test |
| 141 | (I-4) | Tetraethylammonium oxalate | According to test |
| 142 | (I-4) | Tetraethylammonium formate | According to test |
| 143 | (I-4) | Tetraethylammonium hydrogenphosphate | According to test |
| 144 | (I-4) | Tetraethylammonium dihydrogenphosphate | According to test |
| 145 | (I-5) | Ammonium sulphate | According to test |
| 146 | (I-5) | Ammonium lactate | According to test |
| 147 | (I-5) | Ammonium nitrate | According to test |
| 148 | (I-5) | Ammonium thiosulphate | According to test |
| 149 | (I-5) | Ammonium thiocyanate | According to test |
| 150 | (I-5) | Ammonium citrate | According to test |
| 151 | (I-5) | Ammonium oxalate | According to test |
| 152 | (I-5) | Ammonium formate | According to test |
| 153 | (I-5) | Ammonium hydrogenphosphate | According to test |
| 154 | (I-5) | Ammonium dihydrogenphosphate | According to test |
| 155 | (I-5) | Ammonium carbonate | According to test |
| 156 | (I-5) | Ammonium sulphite | According to test |
| 157 | (I-5) | Ammonium benzoate | According to test |
| 158 | (I-5) | Ammonium hydrogenoxalate | According to test |
| 159 | (I-5) | Ammonium hydrogencitrate | According to test |
| 160 | (I-5) | Ammonium acetate | According to test |
| 161 | (I-5) | Tetramethylammonium sulphate | According to test |
| 162 | (I-5) | Tetramethylammonium lactate | According to test |
| 163 | (I-5) | Tetramethylammonium nitrate | According to test |
| 164 | (I-5) | Tetramethylammonium thiosulphate | According to test |
| 165 | (I-5) | Tetramethylammonium thiocyanate | According to test |
| 166 | (I-5) | Tetramethylammonium citrate | According to test |
| 167 | (I-5) | Tetramethylammonium oxalate | According to test |
| 168 | (I-5) | Tetramethylammonium formate | According to test |
| 169 | (I-5) | Tetramethylammonium hydrogenphosphate | According to test |
| 170 | (I-5) | Tetramethylammonium dihydrogenphosphate | According to test |
| 171 | (I-5) | Tetraethylammonium sulphate | According to test |
| 172 | (I-5) | Tetraethylammonium lactate | According to test |
| 173 | (I-5) | Tetraethylammonium nitrate | According to test |
| 174 | (I-5) | Tetraethylammonium thiosulphate | According to test |
| 175 | (I-5) | Tetraethylammonium thiocyanate | According to test |
| 176 | (I-5) | Tetraethylammonium citrate | According to test |
| 177 | (I-5) | Tetraethylammonium oxalate | According to test |
| 178 | (I-5) | Tetraethylammonium formate | According to test |
| 179 | (I-5) | Tetraethylammonium hydrogenphosphate | According to test |
| 180 | (I-5) | Tetraethylammonium dihydrogenphosphate | According to test |
| 181 | (I-6) | Ammonium sulphate | According to test |
| 182 | (I-6) | Ammonium lactate | According to test |
| 183 | (I-6) | Ammonium nitrate | According to test |
| 184 | (I-6) | Ammonium thiosulphate | According to test |
| 185 | (I-6) | Ammonium thiocyanate | According to test |
| 186 | (I-6) | Ammonium citrate | According to test |
| 187 | (I-6) | Ammonium oxalate | According to test |
| 188 | (I-6) | Ammonium formate | According to test |
| 189 | (I-6) | Ammonium hydrogenphosphate | According to test |
| 190 | (I-6) | Ammonium dihydrogenphosphate | According to test |
| 191 | (I-6) | Ammonium carbonate | According to test |
| 192 | (I-6) | Ammonium sulphite | According to test |
| 193 | (I-6) | Ammonium benzoate | According to test |
| 194 | (I-6) | Ammonium hydrogenoxalate | According to test |
| 195 | (I-6) | Ammonium hydrogencitrate | According to test |
| 196 | (I-6) | Ammonium acetate | According to test |
| 197 | (I-6) | Tetramethylammonium sulphate | According to test |
| 198 | (I-6) | Tetramethylammonium lactate | According to test |
| 199 | (I-6) | Tetramethylammonium nitrate | According to test |
| 200 | (I-6) | Tetramethylammonium thiosulphate | According to test |
| 201 | (I-6) | Tetramethylammonium thiocyanate | According to test |
| 202 | (I-6) | Tetramethylammonium citrate | According to test |
| 203 | (I-6) | Tetramethylammonium oxalate | According to test |
| 204 | (I-6) | Tetramethylammonium formate | According to test |
| 205 | (I-6) | Tetramethylammonium hydrogenphosphate | According to test |
| 206 | (I-6) | Tetramethylammonium dihydrogenphosphate | According to test |
| 207 | (I-6) | Tetraethylammonium sulphate | According to test |
| 208 | (I-6) | Tetraethylammonium lactate | According to test |
| 209 | (I-6) | Tetraethylammonium nitrate | According to test |
| 210 | (I-6) | Tetraethylammonium thiosulphate | According to test |
| 211 | (I-6) | Tetraethylammonium thiocyanate | According to test |
| 212 | (I-6) | Tetraethylammonium citrate | According to test |
| 213 | (I-6) | Tetraethylammonium oxalate | According to test |
| 214 | (I-6) | Tetraethylammonium formate | According to test |
| 215 | (I-6) | Tetraethylammonium hydrogenphosphate | According to test |
| 216 | (I-6) | Tetraethylammonium dihydrogenphosphate | According to test |
| 217 | (I-7) | Ammonium sulphate | According to test |
| 218 | (I-7) | Ammonium lactate | According to test |
| 219 | (I-7) | Ammonium nitrate | According to test |
| 220 | (I-7) | Ammonium thiosulphate | According to test |
| 221 | (I-7) | Ammonium thiocyanate | According to test |
| 222 | (I-7) | Ammonium citrate | According to test |
| 223 | (I-7) | Ammonium oxalate | According to test |
| 224 | (I-7) | Ammonium formate | According to test |
| 225 | (I-7) | Ammonium hydrogenphosphate | According to test |
| 226 | (I-7) | Ammonium dihydrogenphosphate | According to test |
| 227 | (I-7) | Ammonium carbonate | According to test |
| 228 | (I-7) | Ammonium sulphite | According to test |
| 229 | (I-7) | Ammonium benzoate | According to test |
| 230 | (I-7) | Ammonium hydrogenoxalate | According to test |
| 231 | (I-7) | Ammonium hydrogencitrate | According to test |
| 232 | (I-7) | Ammonium acetate | According to test |
| 233 | (I-7) | Tetramethylammonium sulphate | According to test |
| 234 | (I-7) | Tetramethylammonium lactate | According to test |
| 235 | (I-7) | Tetramethylammonium nitrate | According to test |
| 236 | (I-7) | Tetramethylammonium thiosulphate | According to test |
| 237 | (I-7) | Tetramethylammonium thiocyanate | According to test |
| 238 | (I-7) | Tetramethylammonium citrate | According to test |
| 239 | (I-7) | Tetramethylammonium oxalate | According to test |
| 240 | (I-7) | Tetramethylammonium formate | According to test |
| 241 | (I-7) | Tetramethylammonium hydrogenphosphate | According to test |
| 242 | (I-7) | Tetramethylammonium dihydrogenphosphate | According to test |
| 243 | (I-7) | Tetraethylammonium sulphate | According to test |
| 244 | (I-7) | Tetraethylammonium lactate | According to test |
| 245 | (I-7) | Tetraethylammonium nitrate | According to test |
| 246 | (I-7) | Tetraethylammonium thiosulphate | According to test |
| 247 | (I-7) | Tetraethylammonium thiocyanate | According to test |
| 248 | (I-7) | Tetraethylammonium citrate | According to test |
| 249 | (I-7) | Tetraethylammonium oxalate | According to test |
| 250 | (I-7) | Tetraethylammonium formate | According to test |
| 251 | (I-7) | Tetraethylammonium hydrogenphosphate | According to test |
| 252 | (I-7) | Tetraethylammonium dihydrogenphosphate | According to test |
| 253 | (I-8) | Ammonium sulphate | According to test |
| 254 | (I-8) | Ammonium lactate | According to test |
| 255 | (I-8) | Ammonium nitrate | According to test |
| 256 | (I-8) | Ammonium thiosulphate | According to test |
| 257 | (I-8) | Ammonium thiocyanate | According to test |
| 258 | (I-8) | Ammonium citrate | According to test |
| 259 | (I-8) | Ammonium oxalate | According to test |
| 260 | (I-8) | Ammonium formate | According to test |
| 261 | (I-8) | Ammonium hydrogenphosphate | According to test |
| 262 | (I-8) | Ammonium dihydrogenphosphate | According to test |
| 263 | (I-8) | Ammonium carbonate | According to test |
| 264 | (I-8) | Ammonium sulphite | According to test |
| 265 | (I-8) | Ammonium benzoate | According to test |
| 266 | (I-8) | Ammonium hydrogenoxalate | According to test |
| 267 | (I-8) | Ammonium hydrogencitrate | According to test |
| 268 | (I-8) | Ammonium acetate | According to test |
| 269 | (I-8) | Tetramethylammonium sulphate | According to test |
| 270 | (I-8) | Tetramethylammonium lactate | According to test |
| 271 | (I-8) | Tetramethylammonium nitrate | According to test |
| 272 | (I-8) | Tetramethylammonium thiosulphate | According to test |
| 273 | (I-8) | Tetramethylammonium thiocyanate | According to test |
| 274 | (I-8) | Tetramethylammonium citrate | According to test |
| 275 | (I-8) | Tetramethylammonium oxalate | According to test |
| 276 | (I-8) | Tetramethylammonium formate | According to test |
| 277 | (I-8) | Tetramethylammonium hydrogenphosphate | According to test |
| 278 | (I-8) | Tetramethylammonium dihydrogenphosphate | According to test |
| 279 | (I-8) | Tetraethylammonium sulphate | According to test |
| 280 | (I-8) | Tetraethylammonium lactate | According to test |
| 281 | (I-8) | Tetraethylammonium nitrate | According to test |
| 282 | (I-8) | Tetraethylammonium thiosulphate | According to test |
| 283 | (I-8) | Tetraethylammonium thiocyanate | According to test |
| 284 | (I-8) | Tetraethylammonium citrate | According to test |
| 285 | (I-8) | Tetraethylammonium oxalate | According to test |
| 286 | (I-8) | Tetraethylammonium formate | According to test |
| 287 | (I-8) | Tetraethylammonium hydrogenphosphate | According to test |
| 288 | (I-8) | Tetraethylammonium dihydrogenphosphate | According to test |
| 289 | (I-9) | Ammonium sulphate | According to test |
| 290 | (I-9) | Ammonium lactate | According to test |
| 291 | (I-9) | Ammonium nitrate | According to test |
| 292 | (I-9) | Ammonium thiosulphate | According to test |
| 293 | (I-9) | Ammonium thiocyanate | According to test |
| 294 | (I-9) | Ammonium citrate | According to test |
| 295 | (I-9) | Ammonium oxalate | According to test |
| 296 | (I-9) | Ammonium formate | According to test |
| 297 | (I-9) | Ammonium hydrogenphosphate | According to test |
| 298 | (I-9) | Ammonium dihydrogenphosphate | According to test |
| 299 | (I-9) | Ammonium carbonate | According to test |
| 300 | (I-9) | Ammonium sulphite | According to test |
| 301 | (I-9) | Ammonium benzoate | According to test |
| 302 | (I-9) | Ammonium hydrogenoxalate | According to test |
| 303 | (I-9) | Ammonium hydrogencitrate | According to test |
| 304 | (I-9) | Ammonium acetate | According to test |
| 305 | (I-9) | Tetramethylammonium sulphate | According to test |
| 306 | (I-9) | Tetramethylammonium lactate | According to test |
| 307 | (I-9) | Tetramethylammonium nitrate | According to test |
| 308 | (I-9) | Tetramethylammonium thiosulphate | According to test |
| 309 | (I-9) | Tetramethylammonium thiocyanate | According to test |
| 310 | (I-9) | Tetramethylammonium citrate | According to test |
| 311 | (I-9) | Tetramethylammonium oxalate | According to test |
| 312 | (I-9) | Tetramethylammonium formate | According to test |
| 313 | (I-9) | Tetramethylammonium hydrogenphosphate | According to test |
| 314 | (I-9) | Tetramethylammonium dihydrogenphosphate | According to test |
| 315 | (I-9) | Tetraethylammonium sulphate | According to test |
| 316 | (I-9) | Tetraethylammonium lactate | According to test |
| 317 | (I-9) | Tetraethylammonium nitrate | According to test |
| 318 | (I-9) | Tetraethylammonium thiosulphate | According to test |
| 319 | (I-9) | Tetraethylammonium thiocyanate | According to test |
| 320 | (I-9) | Tetraethylammonium citrate | According to test |
| 321 | (I-9) | Tetraethylammonium oxalate | According to test |
| 322 | (I-9) | Tetraethylammonium formate | According to test |
| 323 | (I-9) | Tetraethylammonium hydrogenphosphate | According to test |
| 324 | (I-9) | Tetraethylammonium dihydrogenphosphate | According to test |
| 325 | (I-10) | Ammonium sulphate | According to test |
| 326 | (I-10) | Ammonium lactate | According to test |
| 327 | (I-10) | Ammonium nitrate | According to test |
| 328 | (I-10) | Ammonium thiosulphate | According to test |
| 329 | (I-10) | Ammonium thiocyanate | According to test |
| 330 | (I-10) | Ammonium citrate | According to test |
| 331 | (I-10) | Ammonium oxalate | According to test |
| 332 | (I-10) | Ammonium formate | According to test |
| 333 | (I-10) | Ammonium hydrogenphosphate | According to test |
| 334 | (I-10) | Ammonium dihydrogenphosphate | According to test |
| 335 | (I-10) | Ammonium carbonate | According to test |
| 336 | (I-10) | Ammonium sulphite | According to test |
| 337 | (I-10) | Ammonium benzoate | According to test |
| 338 | (I-10) | Ammonium hydrogenoxalate | According to test |
| 339 | (I-10) | Ammonium hydrogencitrate | According to test |
| 340 | (I-10) | Ammonium acetate | According to test |
| 341 | (I-10) | Tetramethylammonium sulphate | According to test |
| 342 | (I-10) | Tetramethylammonium lactate | According to test |
| 343 | (I-10) | Tetramethylammonium nitrate | According to test |
| 344 | (I-10) | Tetramethylammonium thiosulphate | According to test |
| 345 | (I-10) | Tetramethylammonium thiocyanate | According to test |
| 346 | (I-10) | Tetramethylammonium citrate | According to test |
| 347 | (I-10) | Tetramethylammonium oxalate | According to test |
| 348 | (I-10) | Tetramethylammonium formate | According to test |
| 349 | (I-10) | Tetramethylammonium hydrogenphosphate | According to test |
| 350 | (I-10) | Tetramethylammonium dihydrogenphosphate | According to test |
| 351 | (I-10) | Tetraethylammonium sulphate | According to test |
| 352 | (I-10) | Tetraethylammonium lactate | According to test |
| 353 | (I-10) | Tetraethylammonium nitrate | According to test |
| 354 | (I-10) | Tetraethylammonium thiosulphate | According to test |
| 355 | (I-10) | Tetraethylammonium thiocyanate | According to test |
| 356 | (I-10) | Tetraethylammonium citrate | According to test |
| 357 | (I-10) | Tetraethylammonium oxalate | According to test |
| 358 | (I-10) | Tetraethylammonium formate | According to test |
| 359 | (I-10) | Tetraethylammonium hydrogenphosphate | According to test |
| 360 | (I-10) | Tetraethylammonium dihydrogenphosphate | According to test |
| 361 | (I-11) | Ammonium sulphate | According to test |
| 362 | (I-11) | Ammonium lactate | According to test |
| 363 | (I-11) | Ammonium nitrate | According to test |
| 364 | (I-11) | Ammonium thiosulphate | According to test |
| 365 | (I-11) | Ammonium thiocyanate | According to test |
| 366 | (I-11) | Ammonium citrate | According to test |
| 367 | (I-11) | Ammonium oxalate | According to test |
| 368 | (I-11) | Ammonium formate | According to test |
| 369 | (I-11) | Ammonium hydrogenphosphate | According to test |
| 370 | (I-11) | Ammonium dihydrogenphosphate | According to test |
| 371 | (I-11) | Ammonium carbonate | According to test |
| 372 | (I-11) | Ammonium sulphite | According to test |
| 373 | (I-11) | Ammonium benzoate | According to test |
| 374 | (I-11) | Ammonium hydrogenoxalate | According to test |
| 375 | (I-11) | Ammonium hydrogencitrate | According to test |
| 376 | (I-11) | Ammonium acetate | According to test |
| 377 | (I-11) | Tetramethylammonium sulphate | According to test |
| 378 | (I-11) | Tetramethylammonium lactate | According to test |
| 379 | (I-11) | Tetramethylammonium nitrate | According to test |
| 380 | (I-11) | Tetramethylammonium thiosulphate | According to test |
| 381 | (I-11) | Tetramethylammonium thiocyanate | According to test |
| 382 | (I-11) | Tetramethylammonium citrate | According to test |
| 383 | (I-11) | Tetramethylammonium oxalate | According to test |
| 384 | (I-11) | Tetramethylammonium formate | According to test |
| 385 | (I-11) | Tetramethylammonium hydrogenphosphate | According to test |
| 386 | (I-11) | Tetramethylammonium dihydrogenphosphate | According to test |
| 387 | (I-11) | Tetraethylammonium sulphate | According to test |
| 388 | (I-11) | Tetraethylammonium lactate | According to test |
| 389 | (I-11) | Tetraethylammonium nitrate | According to test |
| 390 | (I-11) | Tetraethylammonium thiosulphate | According to test |
| 391 | (I-11) | Tetraethylammonium thiocyanate | According to test |
| 392 | (I-11) | Tetraethylammonium citrate | According to test |
| 393 | (I-11) | Tetraethylammonium oxalate | According to test |
| 394 | (I-11) | Tetraethylammonium formate | According to test |
| 395 | (I-11) | Tetraethylammonium hydrogenphosphate | According to test |
| 396 | (I-11) | Tetraethylammonium dihydrogenphosphate | According to test |
| 397 | (I-12) | Ammonium sulphate | According to test |
| 398 | (I-12) | Ammonium lactate | According to test |
| 399 | (I-12) | Ammonium nitrate | According to test |
| 400 | (I-12) | Ammonium thiosulphate | According to test |
| 401 | (I-12) | Ammonium thiocyanate | According to test |
| 402 | (I-12) | Ammonium citrate | According to test |
| 403 | (I-12) | Ammonium oxalate | According to test |
| 404 | (I-12) | Ammonium formate | According to test |
| 405 | (I-12) | Ammonium hydrogenphosphate | According to test |
| 406 | (I-12) | Ammonium dihydrogenphosphate | According to test |
| 407 | (I-12) | Ammonium carbonate | According to test |
| 408 | (I-12) | Ammonium sulphite | According to test |
| 409 | (I-12) | Ammonium benzoate | According to test |
| 410 | (I-12) | Ammonium hydrogenoxalate | According to test |
| 411 | (I-12) | Ammonium hydrogencitrate | According to test |
| 412 | (I-12) | Ammonium acetate | According to test |
| 413 | (I-12) | Tetramethylammonium sulphate | According to test |
| 414 | (I-12) | Tetramethylammonium lactate | According to test |
| 415 | (I-12) | Tetramethylammonium nitrate | According to test |
| 416 | (I-12) | Tetramethylammonium thiosulphate | According to test |
| 417 | (I-12) | Tetramethylammonium thiocyanate | According to test |
| 418 | (I-12) | Tetramethylammonium citrate | According to test |
| 419 | (I-12) | Tetramethylammonium oxalate | According to test |
| 420 | (I-12) | Tetramethylammonium formate | According to test |
| 421 | (I-12) | Tetramethylammonium hydrogenphosphate | According to test |
| 422 | (I-12) | Tetramethylammonium dihydrogenphosphate | According to test |
| 423 | (I-12) | Tetraethylammonium sulphate | According to test |
| 424 | (I-12) | Tetraethylammonium lactate | According to test |
| 425 | (I-12) | Tetraethylammonium nitrate | According to test |
| 426 | (I-12) | Tetraethylammonium thiosulphate | According to test |
| 427 | (I-12) | Tetraethylammonium thiocyanate | According to test |
| 428 | (I-12) | Tetraethylammonium citrate | According to test |
| 429 | (I-12) | Tetraethylammonium oxalate | According to test |
| 430 | (I-12) | Tetraethylammonium formate | According to test |
| 431 | (I-12) | Tetraethylammonium hydrogenphosphate | According to test |
| 432 | (I-12) | Tetraethylammonium dihydrogenphosphate | According to test |
| 433 | (I-13) | Ammonium sulphate | According to test |
| 434 | (I-13) | Ammonium lactate | According to test |
| 435 | (I-13) | Ammonium nitrate | According to test |
| 436 | (I-13) | Ammonium thiosulphate | According to test |
| 437 | (I-13) | Ammonium thiocyanate | According to test |
| 438 | (I-13) | Ammonium citrate | According to test |
| 439 | (I-13) | Ammonium oxalate | According to test |
| 440 | (I-13) | Ammonium formate | According to test |
| 441 | (I-13) | Ammonium hydrogenphosphate | According to test |
| 442 | (I-13) | Ammonium dihydrogenphosphate | According to test |
| 443 | (I-13) | Ammonium carbonate | According to test |
| 444 | (I-13) | Ammonium sulphite | According to test |
| 445 | (I-13) | Ammonium benzoate | According to test |
| 446 | (I-13) | Ammonium hydrogenoxalate | According to test |
| 447 | (I-13) | Ammonium hydrogencitrate | According to test |
| 448 | (I-13) | Ammonium acetate | According to test |
| 449 | (I-13) | Tetramethylammonium sulphate | According to test |
| 450 | (I-13) | Tetramethylammonium lactate | According to test |
| 451 | (I-13) | Tetramethylammonium nitrate | According to test |
| 452 | (I-13) | Tetramethylammonium thiosulphate | According to test |
| 453 | (I-13) | Tetramethylammonium thiocyanate | According to test |
| 454 | (I-13) | Tetramethylammonium citrate | According to test |
| 455 | (I-13) | Tetramethylammonium oxalate | According to test |
| 456 | (I-13) | Tetramethylammonium formate | According to test |
| 457 | (I-13) | Tetramethylammonium hydrogenphosphate | According to test |
| 458 | (I-13) | Tetramethylammonium dihydrogenphosphate | According to test |
| 459 | (I-13) | Tetraethylammonium sulphate | According to test |
| 460 | (I-13) | Tetraethylammonium lactate | According to test |
| 461 | (I-13) | Tetraethylammonium nitrate | According to test |
| 462 | (I-13) | Tetraethylammonium thiosulphate | According to test |
| 463 | (I-13) | Tetraethylammonium thiocyanate | According to test |
| 464 | (I-13) | Tetraethylammonium citrate | According to test |
| 465 | (I-13) | Tetraethylammonium oxalate | According to test |
| 466 | (I-13) | Tetraethylammonium formate | According to test |
| 467 | (I-13) | Tetraethylammonium hydrogenphosphate | According to test |
| 468 | (I-13) | Tetraethylammonium dihydrogenphosphate | According to test |
| 469 | (I-14) | Ammonium sulphate | According to test |
| 470 | (I-14) | Ammonium lactate | According to test |
| 471 | (I-14) | Ammonium nitrate | According to test |
| 472 | (I-14) | Ammonium thiosulphate | According to test |
| 473 | (I-14) | Ammonium thiocyanate | According to test |
| 474 | (I-14) | Ammonium citrate | According to test |
| 475 | (I-14) | Ammonium oxalate | According to test |
| 476 | (I-14) | Ammonium formate | According to test |
| 477 | (I-14) | Ammonium hydrogenphosphate | According to test |
| 478 | (I-14) | Ammonium dihydrogenphosphate | According to test |
| 479 | (I-14) | Ammonium carbonate | According to test |
| 480 | (I-14) | Ammonium sulphite | According to test |
| 481 | (I-14) | Ammonium benzoate | According to test |
| 482 | (I-14) | Ammonium hydrogenoxalate | According to test |
| 483 | (I-14) | Ammonium hydrogencitrate | According to test |
| 484 | (I-14) | Ammonium acetate | According to test |
| 485 | (I-14) | Tetramethylammonium sulphate | According to test |
| 486 | (I-14) | Tetramethylammonium lactate | According to test |
| 487 | (I-14) | Tetramethylammonium nitrate | According to test |
| 488 | (I-14) | Tetramethylammonium thiosulphate | According to test |
| 489 | (I-14) | Tetramethylammonium thiocyanate | According to test |
| 490 | (I-14) | Tetramethylammonium citrate | According to test |
| 491 | (I-14) | Tetramethylammonium oxalate | According to test |
| 492 | (I-14) | Tetramethylammonium formate | According to test |
| 493 | (I-14) | Tetramethylammonium hydrogenphosphate | According to test |
| 494 | (I-14) | Tetramethylammonium dihydrogenphosphate | According to test |
| 495 | (I-14) | Tetraethylammonium sulphate | According to test |
| 496 | (I-14) | Tetraethylammonium lactate | According to test |
| 497 | (I-14) | Tetraethylammonium nitrate | According to test |
| 498 | (I-14) | Tetraethylammonium thiosulphate | According to test |
| 499 | (I-14) | Tetraethylammonium thiocyanate | According to test |
| 500 | (I-14) | Tetraethylammonium citrate | According to test |
| 501 | (I-14) | Tetraethylammonium oxalate | According to test |
| 502 | (I-14) | Tetraethylammonium formate | According to test |
| 503 | (I-14) | Tetraethylammonium hydrogenphosphate | According to test |
| 504 | (I-14) | Tetraethylammonium dihydrogenphosphate | According to test |
| 505 | (I-15) | Ammonium sulphate | According to test |
| 506 | (I-15) | Ammonium lactate | According to test |
| 507 | (I-15) | Ammonium nitrate | According to test |
| 508 | (I-15) | Ammonium thiosulphate | According to test |
| 509 | (I-15) | Ammonium thiocyanate | According to test |
| 510 | (I-15) | Ammonium citrate | According to test |
| 511 | (I-15) | Ammonium oxalate | According to test |
| 512 | (I-15) | Ammonium formate | According to test |
| 513 | (I-15) | Ammonium hydrogenphosphate | According to test |
| 514 | (I-15) | Ammonium dihydrogenphosphate | According to test |
| 515 | (I-15) | Ammonium carbonate | According to test |
| 516 | (I-15) | Ammonium sulphite | According to test |
| 517 | (I-15) | Ammonium benzoate | According to test |
| 518 | (I-15) | Ammonium hydrogenoxalate | According to test |
| 519 | (I-15) | Ammonium hydrogencitrate | According to test |
| 520 | (I-15) | Ammonium acetate | According to test |
| 521 | (I-15) | Tetramethylammonium sulphate | According to test |
| 522 | (I-15) | Tetramethylammonium lactate | According to test |
| 523 | (I-15) | Tetramethylammonium nitrate | According to test |
| 524 | (I-15) | Tetramethylammonium thiosulphate | According to test |
| 525 | (I-15) | Tetramethylammonium thiocyanate | According to test |
| 526 | (I-15) | Tetramethylammonium citrate | According to test |
| 527 | (I-15) | Tetramethylammonium oxalate | According to test |
| 528 | (I-15) | Tetramethylammonium formate | According to test |
| 529 | (I-15) | Tetramethylammonium hydrogenphosphate | According to test |
| 530 | (I-15) | Tetramethylammonium dihydrogenphosphate | According to test |
| 531 | (I-15) | Tetraethylammonium sulphate | According to test |
| 532 | (I-15) | Tetraethylammonium lactate | According to test |
| 533 | (I-15) | Tetraethylammonium nitrate | According to test |
| 534 | (I-15) | Tetraethylammonium thiosulphate | According to test |
| 535 | (I-15) | Tetraethylammonium thiocyanate | According to test |
| 536 | (I-15) | Tetraethylammonium citrate | According to test |
| 537 | (I-15) | Tetraethylammonium oxalate | According to test |
| 538 | (I-15) | Tetraethylammonium formate | According to test |
| 539 | (I-15) | Tetraethylammonium hydrogenphosphate | According to test |
| 540 | (I-15) | Tetraethylammonium dihydrogenphosphate | According to test |
| 541 | (I-16) | Ammonium sulphate | According to test |
| 542 | (I-16) | Ammonium lactate | According to test |
| 543 | (I-16) | Ammonium nitrate | According to test |
| 544 | (I-16) | Ammonium thiosulphate | According to test |
| 545 | (I-16) | Ammonium thiocyanate | According to test |
| 546 | (I-16) | Ammonium citrate | According to test |
| 547 | (I-16) | Ammonium oxalate | According to test |
| 548 | (I-16) | Ammonium formate | According to test |
| 549 | (I-16) | Ammonium hydrogenphosphate | According to test |
| 550 | (I-16) | Ammonium dihydrogenphosphate | According to test |
| 551 | (I-16) | Ammonium carbonate | According to test |
| 552 | (I-16) | Ammonium sulphite | According to test |
| 553 | (I-16) | Ammonium benzoate | According to test |
| 554 | (I-16) | Ammonium hydrogenoxalate | According to test |
| 555 | (I-16) | Ammonium hydrogencitrate | According to test |
| 556 | (I-16) | Ammonium acetate | According to test |
| 557 | (I-16) | Tetramethylammonium sulphate | According to test |
| 558 | (I-16) | Tetramethylammonium lactate | According to test |
| 559 | (I-16) | Tetramethylammonium nitrate | According to test |
| 560 | (I-16) | Tetramethylammonium thiosulphate | According to test |
| 561 | (I-16) | Tetramethylammonium thiocyanate | According to test |
| 562 | (I-16) | Tetramethylammonium citrate | According to test |
| 563 | (I-16) | Tetramethylammonium oxalate | According to test |
| 564 | (I-16) | Tetramethylammonium formate | According to test |
| 565 | (I-16) | Tetramethylammonium hydrogenphosphate | According to test |
| 566 | (I-16) | Tetramethylammonium dihydrogenphosphate | According to test |
| 567 | (I-16) | Tetraethylammonium sulphate | According to test |
| 568 | (I-16) | Tetraethylammonium lactate | According to test |
| 569 | (I-16) | Tetraethylammonium nitrate | According to test |
| 570 | (I-16) | Tetraethylammonium thiosulphate | According to test |
| 571 | (I-16) | Tetraethylammonium thiocyanate | According to test |
| 572 | (I-16) | Tetraethylammonium citrate | According to test |
| 573 | (I-16) | Tetraethylammonium oxalate | According to test |
| 574 | (I-16) | Tetraethylammonium formate | According to test |
| 575 | (I-16) | Tetraethylammonium hydrogenphosphate | According to test |
| 576 | (I-16) | Tetraethylammonium dihydrogenphosphate | According to test |
| 577 | (I-17) | Ammonium sulphate | According to test |
| 578 | (I-17) | Ammonium lactate | According to test |
| 579 | (I-17) | Ammonium nitrate | According to test |
| 580 | (I-17) | Ammonium thiosulphate | According to test |
| 581 | (I-17) | Ammonium thiocyanate | According to test |
| 582 | (I-17) | Ammonium citrate | According to test |
| 583 | (I-17) | Ammonium oxalate | According to test |
| 584 | (I-17) | Ammonium formate | According to test |
| 585 | (I-17) | Ammonium hydrogenphosphate | According to test |
| 586 | (I-17) | Ammonium dihydrogenphosphate | According to test |
| 587 | (I-17) | Ammonium carbonate | According to test |
| 588 | (I-17) | Ammonium sulphite | According to test |
| 589 | (I-17) | Ammonium benzoate | According to test |
| 590 | (I-17) | Ammonium hydrogenoxalate | According to test |
| 591 | (I-17) | Ammonium hydrogencitrate | According to test |
| 592 | (I-17) | Ammonium acetate | According to test |
| 593 | (I-17) | Tetramethylammonium sulphate | According to test |
| 594 | (I-17) | Tetramethylammonium lactate | According to test |
| 595 | (I-17) | Tetramethylammonium nitrate | According to test |
| 596 | (I-17) | Tetramethylammonium thiosulphate | According to test |
| 597 | (I-17) | Tetramethylammonium thiocyanate | According to test |
| 598 | (I-17) | Tetramethylammonium citrate | According to test |
| 599 | (I-17) | Tetramethylammonium oxalate | According to test |
| 600 | (I-17) | Tetramethylammonium formate | According to test |
| 601 | (I-17) | Tetramethylammonium hydrogenphosphate | According to test |
| 602 | (I-17) | Tetramethylammonium dihydrogenphosphate | According to test |
| 603 | (I-17) | Tetraethylammonium sulphate | According to test |
| 604 | (I-17) | Tetraethylammonium lactate | According to test |
| 605 | (I-17) | Tetraethylammonium nitrate | According to test |
| 606 | (I-17) | Tetraethylammonium thiosulphate | According to test |
| 607 | (I-17) | Tetraethylammonium thiocyanate | According to test |
| 608 | (I-17) | Tetraethylammonium citrate | According to test |
| 609 | (I-17) | Tetraethylammonium oxalate | According to test |
| 610 | (I-17) | Tetraethylammonium formate | According to test |
| 611 | (I-17) | Tetraethylammonium hydrogenphosphate | According to test |
| 612 | (I-17) | Tetraethylammonium dihydrogenphosphate | According to test |
| 613 | (I-18) | Ammonium sulphate | According to test |
| 614 | (I-18) | Ammonium lactate | According to test |
| 615 | (I-18) | Ammonium nitrate | According to test |
| 616 | (I-18) | Ammonium thiosulphate | According to test |
| 617 | (I-18) | Ammonium thiocyanate | According to test |
| 618 | (I-18) | Ammonium citrate | According to test |
| 619 | (I-18) | Ammonium oxalate | According to test |
| 620 | (I-18) | Ammonium formate | According to test |
| 621 | (I-18) | Ammonium hydrogenphosphate | According to test |
| 622 | (I-18) | Ammonium dihydrogenphosphate | According to test |
| 623 | (I-18) | Ammonium carbonate | According to test |
| 624 | (I-18) | Ammonium sulphite | According to test |
| 625 | (I-18) | Ammonium benzoate | According to test |
| 626 | (I-18) | Ammonium hydrogenoxalate | According to test |
| 627 | (I-18) | Ammonium hydrogencitrate | According to test |
| 628 | (I-18) | Ammonium acetate | According to test |
| 629 | (I-18) | Tetramethylammonium sulphate | According to test |
| 630 | (I-18) | Tetramethylammonium lactate | According to test |
| 631 | (I-18) | Tetramethylammonium nitrate | According to test |
| 632 | (I-18) | Tetramethylammonium thiosulphate | According to test |
| 633 | (I-18) | Tetramethylammonium thiocyanate | According to test |
| 634 | (I-18) | Tetramethylammonium citrate | According to test |
| 635 | (I-18) | Tetramethylammonium oxalate | According to test |
| 636 | (I-18) | Tetramethylammonium formate | According to test |
| 637 | (I-18) | Tetramethylammonium hydrogenphosphate | According to test |
| 638 | (I-18) | Tetramethylammonium dihydrogenphosphate | According to test |
| 639 | (I-18) | Tetraethylammonium sulphate | According to test |
| 640 | (I-18) | Tetraethylammonium lactate | According to test |
| 641 | (I-18) | Tetraethylammonium nitrate | According to test |
| 642 | (I-18) | Tetraethylammonium thiosulphate | According to test |
| 643 | (I-18) | Tetraethylammonium thiocyanate | According to test |
| 644 | (I-18) | Tetraethylammonium citrate | According to test |
| 645 | (I-18) | Tetraethylammonium oxalate | According to test |
| 646 | (I-18) | Tetraethylammonium formate | According to test |
| 647 | (I-18) | Tetraethylammonium hydrogenphosphate | According to test |
| 648 | (I-18) | Tetraethylammonium dihydrogenphosphate | According to test |
| 649 | (I-19) | Ammonium sulphate | According to test |
| 650 | (I-19) | Ammonium lactate | According to test |
| 651 | (I-19) | Ammonium nitrate | According to test |
| 652 | (I-19) | Ammonium thiosulphate | According to test |
| 653 | (I-19) | Ammonium thiocyanate | According to test |
| 654 | (I-19) | Ammonium citrate | According to test |
| 655 | (I-19) | Ammonium oxalate | According to test |
| 656 | (I-19) | Ammonium formate | According to test |
| 657 | (I-19) | Ammonium hydrogenphosphate | According to test |
| 658 | (I-19) | Ammonium dihydrogenphosphate | According to test |
| 659 | (I-19) | Ammonium carbonate | According to test |
| 660 | (I-19) | Ammonium sulphite | According to test |
| 661 | (I-19) | Ammonium benzoate | According to test |
| 662 | (I-19) | Ammonium hydrogenoxalate | According to test |
| 663 | (I-19) | Ammonium hydrogencitrate | According to test |
| 664 | (I-19) | Ammonium acetate | According to test |
| 665 | (I-19) | Tetramethylammonium sulphate | According to test |
| 666 | (I-19) | Tetramethylammonium lactate | According to test |
| 667 | (I-19) | Tetramethylammonium nitrate | According to test |
| 668 | (I-19) | Tetramethylammonium thiosulphate | According to test |
| 669 | (I-19) | Tetramethylammonium thiocyanate | According to test |
| 670 | (I-19) | Tetramethylammonium citrate | According to test |
| 671 | (I-19) | Tetramethylammonium oxalate | According to test |
| 672 | (I-19) | Tetramethylammonium formate | According to test |
| 673 | (I-19) | Tetramethylammonium hydrogenphosphate | According to test |
| 674 | (I-19) | Tetramethylammonium dihydrogenphosphate | According to test |
| 675 | (I-19) | Tetraethylammonium sulphate | According to test |
| 676 | (I-19) | Tetraethylammonium lactate | According to test |
| 677 | (I-19) | Tetraethylammonium nitrate | According to test |
| 678 | (I-19) | Tetraethylammonium thiosulphate | According to test |
| 679 | (I-19) | Tetraethylammonium thiocyanate | According to test |
| 680 | (I-19) | Tetraethylammonium citrate | According to test |
| 681 | (I-19) | Tetraethylammonium oxalate | According to test |
| 682 | (I-19) | Tetraethylammonium formate | According to test |
| 683 | (I-19) | Tetraethylammonium hydrogenphosphate | According to test |
| 684 | (I-19) | Tetraethylammonium dihydrogenphosphate | According to test |
| 685 | (I-20) | Ammonium sulphate | According to test |
| 686 | (I-20) | Ammonium lactate | According to test |
| 687 | (I-20) | Ammonium nitrate | According to test |
| 688 | (I-20) | Ammonium thiosulphate | According to test |
| 689 | (I-20) | Ammonium thiocyanate | According to test |
| 690 | (I-20) | Ammonium citrate | According to test |
| 691 | (I-20) | Ammonium oxalate | According to test |
| 692 | (I-20) | Ammonium formate | According to test |
| 693 | (I-20) | Ammonium hydrogenphosphate | According to test |
| 694 | (I-20) | Ammonium dihydrogenphosphate | According to test |
| 695 | (I-20) | Ammonium carbonate | According to test |
| 696 | (I-20) | Ammonium sulphite | According to test |
| 697 | (I-20) | Ammonium benzoate | According to test |
| 698 | (I-20) | Ammonium hydrogenoxalate | According to test |
| 699 | (I-20) | Ammonium hydrogencitrate | According to test |
| 700 | (I-20) | Ammonium acetate | According to test |
| 701 | (I-20) | Tetramethylammonium sulphate | According to test |
| 702 | (I-20) | Tetramethylammonium lactate | According to test |
| 703 | (I-20) | Tetramethylammonium nitrate | According to test |
| 704 | (I-20) | Tetramethylammonium thiosulphate | According to test |
| 705 | (I-20) | Tetramethylammonium thiocyanate | According to test |
| 706 | (I-20) | Tetramethylammonium citrate | According to test |
| 707 | (I-20) | Tetramethylammonium oxalate | According to test |
| 708 | (I-20) | Tetramethylammonium formate | According to test |
| 709 | (I-20) | Tetramethylammonium hydrogenphosphate | According to test |
| 710 | (I-20) | Tetramethylammonium dihydrogenphosphate | According to test |
| 711 | (I-20) | Tetraethylammonium sulphate | According to test |
| 712 | (I-20) | Tetraethylammonium lactate | According to test |
| 713 | (I-20) | Tetraethylammonium nitrate | According to test |
| 714 | (I-20) | Tetraethylammonium thiosulphate | According to test |
| 715 | (I-20) | Tetraethylammonium thiocyanate | According to test |
| 716 | (I-20) | Tetraethylammonium citrate | According to test |
| 717 | (I-20) | Tetraethylammonium oxalate | According to test |
| 718 | (I-20) | Tetraethylammonium formate | According to test |
| 719 | (I-20) | Tetraethylammonium hydrogenphosphate | According to test |
| 720 | (I-20) | Tetraethylammonium dihydrogenphosphate | According to test |
| 721 | (I-21) | Ammonium sulphate | According to test |
| 722 | (I-21) | Ammonium lactate | According to test |
| 723 | (I-21) | Ammonium nitrate | According to test |
| 724 | (I-21) | Ammonium thiosulphate | According to test |
| 725 | (I-21) | Ammonium thiocyanate | According to test |
| 726 | (I-21) | Ammonium citrate | According to test |
| 727 | (I-21) | Ammonium oxalate | According to test |
| 728 | (I-21) | Ammonium formate | According to test |
| 729 | (I-21) | Ammonium hydrogenphosphate | According to test |
| 730 | (I-21) | Ammonium dihydrogenphosphate | According to test |
| 731 | (I-21) | Ammonium carbonate | According to test |
| 732 | (I-21) | Ammonium sulphite | According to test |
| 733 | (I-21) | Ammonium benzoate | According to test |
| 734 | (I-21) | Ammonium hydrogenoxalate | According to test |
| 735 | (I-21) | Ammonium hydrogencitrate | According to test |
| 736 | (I-21) | Ammonium acetate | According to test |
| 737 | (I-21) | Tetramethylammonium sulphate | According to test |
| 738 | (I-21) | Tetramethylammonium lactate | According to test |
| 739 | (I-21) | Tetramethylammonium nitrate | According to test |
| 740 | (I-21) | Tetramethylammonium thiosulphate | According to test |
| 741 | (I-21) | Tetramethylammonium thiocyanate | According to test |
| 742 | (I-21) | Tetramethylammonium citrate | According to test |
| 743 | (I-21) | Tetramethylammonium oxalate | According to test |
| 744 | (I-21) | Tetramethylammonium formate | According to test |
| 745 | (I-21) | Tetramethylammonium hydrogenphosphate | According to test |
| 746 | (I-21) | Tetramethylammonium dihydrogenphosphate | According to test |
| 747 | (I-21) | Tetraethylammonium sulphate | According to test |
| 748 | (I-21) | Tetraethylammonium lactate | According to test |
| 749 | (I-21) | Tetraethylammonium nitrate | According to test |
| 750 | (I-21) | Tetraethylammonium thiosulphate | According to test |
| 751 | (I-21) | Tetraethylammonium thiocyanate | According to test |
| 752 | (I-21) | Tetraethylammonium citrate | According to test |
| 753 | (I-21) | Tetraethylammonium oxalate | According to test |
| 754 | (I-21) | Tetraethylammonium formate | According to test |
| 755 | (I-21) | Tetraethylammonium hydrogenphosphate | According to test |
| 756 | (I-21) | Tetraethylammonium dihydrogenphosphate | According to test |
| 757 | (I-22) | Ammonium sulphate | According to test |
| 758 | (I-22) | Ammonium lactate | According to test |
| 759 | (I-22) | Ammonium nitrate | According to test |
| 760 | (I-22) | Ammonium thiosulphate | According to test |
| 761 | (I-22) | Ammonium thiocyanate | According to test |
| 762 | (I-22) | Ammonium citrate | According to test |
| 763 | (I-22) | Ammonium oxalate | According to test |
| 764 | (I-22) | Ammonium formate | According to test |
| 765 | (I-22) | Ammonium hydrogenphosphate | According to test |
| 766 | (I-22) | Ammonium dihydrogenphosphate | According to test |
| 767 | (I-22) | Ammonium carbonate | According to test |
| 768 | (I-22) | Ammonium sulphite | According to test |
| 769 | (I-22) | Ammonium benzoate | According to test |
| 770 | (I-22) | Ammonium hydrogenoxalate | According to test |
| 771 | (I-22) | Ammonium hydrogencitrate | According to test |
| 772 | (I-22) | Ammonium acetate | According to test |
| 773 | (I-22) | Tetramethylammonium sulphate | According to test |
| 774 | (I-22) | Tetramethylammonium lactate | According to test |
| 775 | (I-22) | Tetramethylammonium nitrate | According to test |
| 776 | (I-22) | Tetramethylammonium thiosulphate | According to test |
| 777 | (I-22) | Tetramethylammonium thiocyanate | According to test |
| 778 | (I-22) | Tetramethylammonium citrate | According to test |
| 779 | (I-22) | Tetramethylammonium oxalate | According to test |
| 780 | (I-22) | Tetramethylammonium formate | According to test |
| 781 | (I-22) | Tetramethylammonium hydrogenphosphate | According to test |
| 782 | (I-22) | Tetramethylammonium dihydrogenphosphate | According to test |
| 783 | (I-22) | Tetraethylammonium sulphate | According to test |
| 784 | (I-22) | Tetraethylammonium lactate | According to test |
| 785 | (I-22) | Tetraethylammonium nitrate | According to test |
| 786 | (I-22) | Tetraethylammonium thiosulphate | According to test |
| 787 | (I-22) | Tetraethylammonium thiocyanate | According to test |
| 788 | (I-22) | Tetraethylammonium citrate | According to test |
| 789 | (I-22) | Tetraethylammonium oxalate | According to test |
| 790 | (I-22) | Tetraethylammonium formate | According to test |
| 791 | (I-22) | Tetraethylammonium hydrogenphosphate | According to test |
| 792 | (I-22) | Tetraethylammonium dihydrogenphosphate | According to test |
| 793 | (I-23) | Ammonium sulphate | According to test |
| 794 | (I-23) | Ammonium lactate | According to test |
| 795 | (I-23) | Ammonium nitrate | According to test |
| 796 | (I-23) | Ammonium thiosulphate | According to test |
| 797 | (I-23) | Ammonium thiocyanate | According to test |
| 798 | (I-23) | Ammonium citrate | According to test |
| 799 | (I-23) | Ammonium oxalate | According to test |
| 800 | (I-23) | Ammonium formate | According to test |
| 801 | (I-23) | Ammonium hydrogenphosphate | According to test |
| 802 | (I-23) | Ammonium dihydrogenphosphate | According to test |
| 803 | (I-23) | Ammonium carbonate | According to test |
| 804 | (I-23) | Ammonium sulphite | According to test |
| 805 | (I-23) | Ammonium benzoate | According to test |
| 806 | (I-23) | Ammonium hydrogenoxalate | According to test |
| 807 | (I-23) | Ammonium hydrogencitrate | According to test |
| 808 | (I-23) | Ammonium acetate | According to test |
| 809 | (I-23) | Tetramethylammonium sulphate | According to test |
| 810 | (I-23) | Tetramethylammonium lactate | According to test |
| 811 | (I-23) | Tetramethylammonium nitrate | According to test |
| 812 | (I-23) | Tetramethylammonium thiosulphate | According to test |
| 813 | (I-23) | Tetramethylammonium thiocyanate | According to test |
| 814 | (I-23) | Tetramethylammonium citrate | According to test |
| 815 | (I-23) | Tetramethylammonium oxalate | According to test |
| 816 | (I-23) | Tetramethylammonium formate | According to test |
| 817 | (I-23) | Tetramethylammonium hydrogenphosphate | According to test |
| 818 | (I-23) | Tetramethylammonium dihydrogenphosphate | According to test |
| 819 | (I-23) | Tetraethylammonium sulphate | According to test |
| 820 | (I-23) | Tetraethylammonium lactate | According to test |
| 821 | (I-23) | Tetraethylammonium nitrate | According to test |
| 822 | (I-23) | Tetraethylammonium thiosulphate | According to test |
| 823 | (I-23) | Tetraethylammonium thiocyanate | According to test |
| 824 | (I-23) | Tetraethylammonium citrate | According to test |
| 825 | (I-23) | Tetraethylammonium oxalate | According to test |
| 826 | (I-23) | Tetraethylammonium formate | According to test |
| 827 | (I-23) | Tetraethylammonium hydrogenphosphate | According to test |
| 828 | (I-23) | Tetraethylammonium dihydrogenphosphate | According to test |
| 829 | (I-24) | Ammonium sulphate | According to test |
| 830 | (I-24) | Ammonium lactate | According to test |
| 831 | (I-24) | Ammonium nitrate | According to test |
| 832 | (I-24) | Ammonium thiosulphate | According to test |
| 833 | (I-24) | Ammonium thiocyanate | According to test |
| 834 | (I-24) | Ammonium citrate | According to test |
| 835 | (I-24) | Ammonium oxalate | According to test |
| 836 | (I-24) | Ammonium formate | According to test |
| 837 | (I-24) | Ammonium hydrogenphosphate | According to test |
| 838 | (I-24) | Ammonium dihydrogenphosphate | According to test |
| 839 | (I-24) | Ammonium carbonate | According to test |
| 840 | (I-24) | Ammonium sulphite | According to test |
| 841 | (I-24) | Ammonium benzoate | According to test |
| 842 | (I-24) | Ammonium hydrogenoxalate | According to test |
| 843 | (I-24) | Ammonium hydrogencitrate | According to test |
| 844 | (I-24) | Ammonium acetate | According to test |
| 845 | (I-24) | Tetramethylammonium sulphate | According to test |
| 846 | (I-24) | Tetramethylammonium lactate | According to test |
| 847 | (I-24) | Tetramethylammonium nitrate | According to test |
| 848 | (I-24) | Tetramethylammonium thiosulphate | According to test |
| 849 | (I-24) | Tetramethylammonium thiocyanate | According to test |
| 850 | (I-24) | Tetramethylammonium citrate | According to test |
| 851 | (I-24) | Tetramethylammonium oxalate | According to test |
| 852 | (I-24) | Tetramethylammonium formate | According to test |
| 853 | (I-24) | Tetramethylammonium hydrogenphosphate | According to test |
| 854 | (I-24) | Tetramethylammonium dihydrogenphosphate | According to test |
| 855 | (I-24) | Tetraethylammonium sulphate | According to test |
| 856 | (I-24) | Tetraethylammonium lactate | According to test |
| 857 | (I-24) | Tetraethylammonium nitrate | According to test |
| 858 | (I-24) | Tetraethylammonium thiosulphate | According to test |
| 859 | (I-24) | Tetraethylammonium thiocyanate | According to test |
| 860 | (I-24) | Tetraethylammonium citrate | According to test |
| 861 | (I-24) | Tetraethylammonium oxalate | According to test |
| 862 | (I-24) | Tetraethylammonium formate | According to test |
| 863 | (I-24) | Tetraethylammonium hydrogenphosphate | According to test |
| 864 | (I-24) | Tetraethylammonium dihydrogenphosphate | According to test |
| 865 | (I-25) | Ammonium sulphate | According to test |
| 866 | (I-25) | Ammonium lactate | According to test |
| 867 | (I-25) | Ammonium nitrate | According to test |
| 868 | (I-25) | Ammonium thiosulphate | According to test |
| 869 | (I-25) | Ammonium thiocyanate | According to test |
| 870 | (I-25) | Ammonium citrate | According to test |
| 871 | (I-25) | Ammonium oxalate | According to test |
| 872 | (I-25) | Ammonium formate | According to test |
| 873 | (I-25) | Ammonium hydrogenphosphate | According to test |
| 874 | (I-25) | Ammonium dihydrogenphosphate | According to test |
| 875 | (I-25) | Ammonium carbonate | According to test |
| 876 | (I-25) | Ammonium sulphite | According to test |
| 877 | (I-25) | Ammonium benzoate | According to test |
| 878 | (I-25) | Ammonium hydrogenoxalate | According to test |
| 879 | (I-25) | Ammonium hydrogencitrate | According to test |
| 880 | (I-25) | Ammonium acetate | According to test |
| 881 | (I-25) | Tetramethylammonium sulphate | According to test |
| 882 | (I-25) | Tetramethylammonium lactate | According to test |
| 883 | (I-25) | Tetramethylammonium nitrate | According to test |
| 884 | (I-25) | Tetramethylammonium thiosulphate | According to test |
| 885 | (I-25) | Tetramethylammonium thiocyanate | According to test |
| 886 | (I-25) | Tetramethylammonium citrate | According to test |
| 887 | (I-25) | Tetramethylammonium oxalate | According to test |
| 888 | (I-25) | Tetramethylammonium formate | According to test |
| 889 | (I-25) | Tetramethylammonium hydrogenphosphate | According to test |
| 890 | (I-25) | Tetramethylammonium dihydrogenphosphate | According to test |
| 891 | (I-25) | Tetraethylammonium sulphate | According to test |
| 892 | (I-25) | Tetraethylammonium lactate | According to test |
| 893 | (I-25) | Tetraethylammonium nitrate | According to test |
| 894 | (I-25) | Tetraethylammonium thiosulphate | According to test |
| 895 | (I-25) | Tetraethylammonium thiocyanate | According to test |
| 896 | (I-25) | Tetraethylammonium citrate | According to test |
| 897 | (I-25) | Tetraethylammonium oxalate | According to test |
| 898 | (I-25) | Tetraethylammonium formate | According to test |
| 899 | (I-25) | Tetraethylammonium hydrogenphosphate | According to test |
| 900 | (I-25) | Tetraethylammonium dihydrogenphosphate | According to test |
| 901 | (I-26) | Ammonium sulphate | According to test |
| 902 | (I-26) | Ammonium lactate | According to test |
| 903 | (I-26) | Ammonium nitrate | According to test |
| 904 | (I-26) | Ammonium thiosulphate | According to test |
| 905 | (I-26) | Ammonium thiocyanate | According to test |
| 906 | (I-26) | Ammonium citrate | According to test |
| 907 | (I-26) | Ammonium oxalate | According to test |
| 908 | (I-26) | Ammonium formate | According to test |
| 909 | (I-26) | Ammonium hydrogenphosphate | According to test |
| 910 | (I-26) | Ammonium dihydrogenphosphate | According to test |
| 911 | (I-26) | Ammonium carbonate | According to test |
| 912 | (I-26) | Ammonium sulphite | According to test |
| 913 | (I-26) | Ammonium benzoate | According to test |
| 914 | (I-26) | Ammonium hydrogenoxalate | According to test |
| 915 | (I-26) | Ammonium hydrogencitrate | According to test |
| 916 | (I-26) | Ammonium acetate | According to test |
| 917 | (I-26) | Tetramethylammonium sulphate | According to test |
| 918 | (I-26) | Tetramethylammonium lactate | According to test |
| 919 | (I-26) | Tetramethylammonium nitrate | According to test |
| 920 | (I-26) | Tetramethylammonium thiosulphate | According to test |
| 921 | (I-26) | Tetramethylammonium thiocyanate | According to test |
| 922 | (I-26) | Tetramethylammonium citrate | According to test |
| 923 | (I-26) | Tetramethylammonium oxalate | According to test |
| 924 | (I-26) | Tetramethylammonium formate | According to test |
| 925 | (I-26) | Tetramethylammonium hydrogenphosphate | According to test |
| 926 | (I-26) | Tetramethylammonium dihydrogenphosphate | According to test |
| 927 | (I-26) | Tetraethylammonium sulphate | According to test |
| 928 | (I-26) | Tetraethylammonium lactate | According to test |
| 929 | (I-26) | Tetraethylammonium nitrate | According to test |
| 930 | (I-26) | Tetraethylammonium thiosulphate | According to test |
| 931 | (I-26) | Tetraethylammonium thiocyanate | According to test |
| 932 | (I-26) | Tetraethylammonium citrate | According to test |
| 933 | (I-26) | Tetraethylammonium oxalate | According to test |
| 934 | (I-26) | Tetraethylammonium formate | According to test |
| 935 | (I-26) | Tetraethylammonium hydrogenphosphate | According to test |
| 936 | (I-26) | Tetraethylammonium dihydrogenphosphate | According to test |
| 937 | (I-27) | Ammonium sulphate | According to test |
| 938 | (I-27) | Ammonium lactate | According to test |
| 939 | (I-27) | Ammonium nitrate | According to test |
| 940 | (I-27) | Ammonium thiosulphate | According to test |
| 941 | (I-27) | Ammonium thiocyanate | According to test |
| 942 | (I-27) | Ammonium citrate | According to test |
| 943 | (I-27) | Ammonium oxalate | According to test |
| 944 | (I-27) | Ammonium formate | According to test |
| 945 | (I-27) | Ammonium hydrogenphosphate | According to test |
| 946 | (I-27) | Ammonium dihydrogenphosphate | According to test |
| 947 | (I-27) | Ammonium carbonate | According to test |
| 948 | (I-27) | Ammonium sulphite | According to test |
| 949 | (I-27) | Ammonium benzoate | According to test |
| 950 | (I-27) | Ammonium hydrogenoxalate | According to test |
| 951 | (I-27) | Ammonium hydrogencitrate | According to test |
| 952 | (I-27) | Ammonium acetate | According to test |
| 953 | (I-27) | Tetramethylammonium sulphate | According to test |
| 954 | (I-27) | Tetramethylammonium lactate | According to test |
| 955 | (I-27) | Tetramethylammonium nitrate | According to test |
| 956 | (I-27) | Tetramethylammonium thiosulphate | According to test |
| 957 | (I-27) | Tetramethylammonium thiocyanate | According to test |
| 958 | (I-27) | Tetramethylammonium citrate | According to test |
| 959 | (I-27) | Tetramethylammonium oxalate | According to test |
| 960 | (I-27) | Tetramethylammonium formate | According to test |
| 961 | (I-27) | Tetramethylammonium hydrogenphosphate | According to test |
| 962 | (I-27) | Tetramethylammonium dihydrogenphosphate | According to test |
| 963 | (I-27) | Tetraethylammonium sulphate | According to test |
| 964 | (I-27) | Tetraethylammonium lactate | According to test |
| 965 | (I-27) | Tetraethylammonium nitrate | According to test |
| 966 | (I-27) | Tetraethylammonium thiosulphate | According to test |
| 967 | (I-27) | Tetraethylammonium thiocyanate | According to test |
| 968 | (I-27) | Tetraethylammonium citrate | According to test |
| 969 | (I-27) | Tetraethylammonium oxalate | According to test |
| 970 | (I-27) | Tetraethylammonium formate | According to test |
| 971 | (I-27) | Tetraethylammonium hydrogenphosphate | According to test |
| 972 | (I-27) | Tetraethylammonium dihydrogenphosphate | According to test |
| 973 | (I-28) | Ammonium sulphate | According to test |
| 974 | (I-28) | Ammonium lactate | According to test |
| 975 | (I-28) | Ammonium nitrate | According to test |
| 976 | (I-28) | Ammonium thiosulphate | According to test |
| 977 | (I-28) | Ammonium thiocyanate | According to test |
| 978 | (I-28) | Ammonium citrate | According to test |
| 979 | (I-28) | Ammonium oxalate | According to test |
| 980 | (I-28) | Ammonium formate | According to test |
| 981 | (I-28) | Ammonium hydrogenphosphate | According to test |
| 982 | (I-28) | Ammonium dihydrogenphosphate | According to test |
| 983 | (I-28) | Ammonium carbonate | According to test |
| 984 | (I-28) | Ammonium sulphite | According to test |
| 985 | (I-28) | Ammonium benzoate | According to test |
| 986 | (I-28) | Ammonium hydrogenoxalate | According to test |
| 987 | (I-28) | Ammonium hydrogencitrate | According to test |
| 988 | (I-28) | Ammonium acetate | According to test |
| 989 | (I-28) | Tetramethylammonium sulphate | According to test |
| 990 | (I-28) | Tetramethylammonium lactate | According to test |
| 991 | (I-28) | Tetramethylammonium nitrate | According to test |
| 992 | (I-28) | Tetramethylammonium thiosulphate | According to test |
| 993 | (I-28) | Tetramethylammonium thiocyanate | According to test |
| 994 | (I-28) | Tetramethylammonium citrate | According to test |
| 995 | (I-28) | Tetramethylammonium oxalate | According to test |
| 996 | (I-28) | Tetramethylammonium formate | According to test |
| 997 | (I-28) | Tetramethylammonium hydrogenphosphate | According to test |
| 998 | (I-28) | Tetramethylammonium dihydrogenphosphate | According to test |
| 999 | (I-28) | Tetraethylammonium sulphate | According to test |
| 1000 | (I-28) | Tetraethylammonium lactate | According to test |
| 1001 | (I-28) | Tetraethylammonium nitrate | According to test |
| 1002 | (I-28) | Tetraethylammonium thiosulphate | According to test |
| 1003 | (I-28) | Tetraethylammonium thiocyanate | According to test |
| 1004 | (I-28) | Tetraethylammonium citrate | According to test |
| 1005 | (I-28) | Tetraethylammonium oxalate | According to test |
| 1006 | (I-28) | Tetraethylammonium formate | According to test |
| 1007 | (I-28) | Tetraethylammonium hydrogenphosphate | According to test |
| 1008 | (I-28) | Tetraethylammonium dihydrogenphosphate | According to test |
| 1009 | (I-29) | Ammonium sulphate | According to test |
| 1010 | (I-29) | Ammonium lactate | According to test |
| 1011 | (I-29) | Ammonium nitrate | According to test |
| 1012 | (I-29) | Ammonium thiosulphate | According to test |
| 1013 | (I-29) | Ammonium thiocyanate | According to test |
| 1014 | (I-29) | Ammonium citrate | According to test |
| 1015 | (I-29) | Ammonium oxalate | According to test |
| 1016 | (I-29) | Ammonium formate | According to test |
| 1017 | (I-29) | Ammonium hydrogenphosphate | According to test |
| 1018 | (I-29) | Ammonium dihydrogenphosphate | According to test |
| 1019 | (I-29) | Ammonium carbonate | According to test |
| 1020 | (I-29) | Ammonium sulphite | According to test |
| 1021 | (I-29) | Ammonium benzoate | According to test |
| 1022 | (I-29) | Ammonium hydrogenoxalate | According to test |
| 1023 | (I-29) | Ammonium hydrogencitrate | According to test |
| 1024 | (I-29) | Ammonium acetate | According to test |
| 1025 | (I-29) | Tetramethylammonium sulphate | According to test |
| 1026 | (I-29) | Tetramethylammonium lactate | According to test |
| 1027 | (I-29) | Tetramethylammonium nitrate | According to test |
| 1028 | (I-29) | Tetramethylammonium thiosulphate | According to test |
| 1029 | (I-29) | Tetramethylammonium thiocyanate | According to test |
| 1030 | (I-29) | Tetramethylammonium citrate | According to test |
| 1031 | (I-29) | Tetramethylammonium oxalate | According to test |
| 1032 | (I-29) | Tetramethylammonium formate | According to test |
| 1033 | (I-29) | Tetramethylammonium hydrogenphosphate | According to test |
| 1034 | (I-29) | Tetramethylammonium dihydrogenphosphate | According to test |
| 1035 | (I-29) | Tetraethylammonium sulphate | According to test |
| 1036 | (I-29) | Tetraethylammonium lactate | According to test |
| 1037 | (I-29) | Tetraethylammonium nitrate | According to test |
| 1038 | (I-29) | Tetraethylammonium thiosulphate | According to test |
| 1039 | (I-29) | Tetraethylammonium thiocyanate | According to test |
| 1040 | (I-29) | Tetraethylammonium citrate | According to test |
| 1041 | (I-29) | Tetraethylammonium oxalate | According to test |
| 1042 | (I-29) | Tetraethylammonium formate | According to test |
| 1043 | (I-29) | Tetraethylammonium hydrogenphosphate | According to test |
| 1044 | (I-29) | Tetraethylammonium dihydrogenphosphate | According to test |
| 1045 | (I-30) | Ammonium sulphate | According to test |
| 1046 | (I-30) | Ammonium lactate | According to test |
| 1047 | (I-30) | Ammonium nitrate | According to test |
| 1048 | (I-30) | Ammonium thiosulphate | According to test |
| 1049 | (I-30) | Ammonium thiocyanate | According to test |
| 1050 | (I-30) | Ammonium citrate | According to test |
| 1051 | (I-30) | Ammonium oxalate | According to test |
| 1052 | (I-30) | Ammonium formate | According to test |
| 1053 | (I-30) | Ammonium hydrogenphosphate | According to test |
| 1054 | (I-30) | Ammonium dihydrogenphosphate | According to test |
| 1055 | (I-30) | Ammonium carbonate | According to test |
| 1056 | (I-30) | Ammonium sulphite | According to test |
| 1057 | (I-30) | Ammonium benzoate | According to test |
| 1058 | (I-30) | Ammonium hydrogenoxalate | According to test |
| 1059 | (I-30) | Ammonium hydrogencitrate | According to test |
| 1060 | (I-30) | Ammonium acetate | According to test |
| 1061 | (I-30) | Tetramethylammonium sulphate | According to test |
| 1062 | (I-30) | Tetramethylammonium lactate | According to test |
| 1063 | (I-30) | Tetramethylammonium nitrate | According to test |
| 1064 | (I-30) | Tetramethylammonium thiosulphate | According to test |
| 1065 | (I-30) | Tetramethylammonium thiocyanate | According to test |
| 1066 | (I-30) | Tetramethylammonium citrate | According to test |
| 1067 | (I-30) | Tetramethylammonium oxalate | According to test |
| 1068 | (I-30) | Tetramethylammonium formate | According to test |
| 1069 | (I-30) | Tetramethylammonium hydrogenphosphate | According to test |
| 1070 | (I-30) | Tetramethylammonium dihydrogenphosphate | According to test |
| 1071 | (I-30) | Tetraethylammonium sulphate | According to test |
| 1072 | (I-30) | Tetraethylammonium lactate | According to test |
| 1073 | (I-30) | Tetraethylammonium nitrate | According to test |
| 1074 | (I-30) | Tetraethylammonium thiosulphate | According to test |
| 1075 | (I-30) | Tetraethylammonium thiocyanate | According to test |
| 1076 | (I-30) | Tetraethylammonium citrate | According to test |
| 1077 | (I-30) | Tetraethylammonium oxalate | According to test |
| 1078 | (I-30) | Tetraethylammonium formate | According to test |
| 1079 | (I-30) | Tetraethylammonium hydrogenphosphate | According to test |
| 1080 | (I-30) | Tetraethylammonium dihydrogenphosphate | According to test |
| 1081 | (I-31) | Ammonium sulphate | According to test |
| 1082 | (I-31) | Ammonium lactate | According to test |
| 1083 | (I-31) | Ammonium nitrate | According to test |
| 1084 | (I-31) | Ammonium thiosulphate | According to test |
| 1085 | (I-31) | Ammonium thiocyanate | According to test |
| 1086 | (I-31) | Ammonium citrate | According to test |
| 1087 | (I-31) | Ammonium oxalate | According to test |
| 1088 | (I-31) | Ammonium formate | According to test |
| 1089 | (I-31) | Ammonium hydrogenphosphate | According to test |
| 1090 | (I-31) | Ammonium dihydrogenphosphate | According to test |
| 1091 | (I-31) | Ammonium carbonate | According to test |
| 1092 | (I-31) | Ammonium sulphite | According to test |
| 1093 | (I-31) | Ammonium benzoate | According to test |
| 1094 | (I-31) | Ammonium hydrogenoxalate | According to test |
| 1095 | (I-31) | Ammonium hydrogencitrate | According to test |
| 1096 | (I-31) | Ammonium acetate | According to test |
| 1097 | (I-31) | Tetramethylammonium sulphate | According to test |
| 1098 | (I-31) | Tetramethylammonium lactate | According to test |
| 1099 | (I-31) | Tetramethylammonium nitrate | According to test |
| 1100 | (I-31) | Tetramethylammonium thiosulphate | According to test |
| 1101 | (I-31) | Tetramethylammonium thiocyanate | According to test |
| 1102 | (I-31) | Tetramethylammonium citrate | According to test |
| 1103 | (I-31) | Tetramethylammonium oxalate | According to test |
| 1104 | (I-31) | Tetramethylammonium formate | According to test |
| 1105 | (I-31) | Tetramethylammonium hydrogenphosphate | According to test |
| 1106 | (I-31) | Tetramethylammonium dihydrogenphosphate | According to test |
| 1107 | (I-31) | Tetraethylammonium sulphate | According to test |
| 1108 | (I-31) | Tetraethylammonium lactate | According to test |
| 1109 | (I-31) | Tetraethylammonium nitrate | According to test |
| 1110 | (I-31) | Tetraethylammonium thiosulphate | According to test |
| 1111 | (I-31) | Tetraethylammonium thiocyanate | According to test |
| 1112 | (I-31) | Tetraethylammonium citrate | According to test |
| 1113 | (I-31) | Tetraethylammonium oxalate | According to test |
| 1114 | (I-31) | Tetraethylammonium formate | According to test |
| 1115 | (I-31) | Tetraethylammonium hydrogenphosphate | According to test |
| 1116 | (I-31) | Tetraethylammonium dihydrogenphosphate | According to test |
| 1117 | (I-32) | Ammonium sulphate | According to test |
| 1118 | (I-32) | Ammonium lactate | According to test |
| 1119 | (I-32) | Ammonium nitrate | According to test |
| 1120 | (I-32) | Ammonium thiosulphate | According to test |
| 1121 | (I-32) | Ammonium thiocyanate | According to test |
| 1122 | (I-32) | Ammonium citrate | According to test |
| 1123 | (I-32) | Ammonium oxalate | According to test |
| 1124 | (I-32) | Ammonium formate | According to test |
| 1125 | (I-32) | Ammonium hydrogenphosphate | According to test |
| 1126 | (I-32) | Ammonium dihydrogenphosphate | According to test |
| 1127 | (I-32) | Ammonium carbonate | According to test |
| 1128 | (I-32) | Ammonium sulphite | According to test |
| 1129 | (I-32) | Ammonium benzoate | According to test |
| 1130 | (I-32) | Ammonium hydrogenoxalate | According to test |
| 1131 | (I-32) | Ammonium hydrogencitrate | According to test |
| 1132 | (I-32) | Ammonium acetate | According to test |
| 1133 | (I-32) | Tetramethylammonium sulphate | According to test |
| 1134 | (I-32) | Tetramethylammonium lactate | According to test |
| 1135 | (I-32) | Tetramethylammonium nitrate | According to test |
| 1136 | (I-32) | Tetramethylammonium thiosulphate | According to test |
| 1137 | (I-32) | Tetramethylammonium thiocyanate | According to test |
| 1138 | (I-32) | Tetramethylammonium citrate | According to test |
| 1139 | (I-32) | Tetramethylammonium oxalate | According to test |
| 1140 | (I-32) | Tetramethylammonium formate | According to test |
| 1141 | (I-32) | Tetramethylammonium hydrogenphosphate | According to test |
| 1142 | (I-32) | Tetramethylammonium dihydrogenphosphate | According to test |
| 1143 | (I-32) | Tetraethylammonium sulphate | According to test |
| 1144 | (I-32) | Tetraethylammonium lactate | According to test |
| 1145 | (I-32) | Tetraethylammonium nitrate | According to test |
| 1146 | (I-32) | Tetraethylammonium thiosulphate | According to test |
| 1147 | (I-32) | Tetraethylammonium thiocyanate | According to test |
| 1148 | (I-32) | Tetraethylammonium citrate | According to test |
| 1149 | (I-32) | Tetraethylammonium oxalate | According to test |
| 1150 | (I-32) | Tetraethylammonium formate | According to test |
| 1151 | (I-32) | Tetraethylammonium hydrogenphosphate | According to test |
| 1152 | (I-32) | Tetraethylammonium dihydrogenphosphate | According to test |
| 1153 | (I-33) | Ammonium sulphate | According to test |
| 1154 | (I-33) | Ammonium lactate | According to test |
| 1155 | (I-33) | Ammonium nitrate | According to test |
| 1156 | (I-33) | Ammonium thiosulphate | According to test |
| 1157 | (I-33) | Ammonium thiocyanate | According to test |
| 1158 | (I-33) | Ammonium citrate | According to test |
| 1159 | (I-33) | Ammonium oxalate | According to test |
| 1160 | (I-33) | Ammonium formate | According to test |
| 1161 | (I-33) | Ammonium hydrogenphosphate | According to test |
| 1162 | (I-33) | Ammonium dihydrogenphosphate | According to test |
| 1163 | (I-33) | Ammonium carbonate | According to test |
| 1164 | (I-33) | Ammonium sulphite | According to test |
| 1165 | (I-33) | Ammonium benzoate | According to test |
| 1166 | (I-33) | Ammonium hydrogenoxalate | According to test |
| 1167 | (I-33) | Ammonium hydrogencitrate | According to test |
| 1168 | (I-33) | Ammonium acetate | According to test |
| 1169 | (I-33) | Tetramethylammonium sulphate | According to test |
| 1170 | (I-33) | Tetramethylammonium lactate | According to test |
| 1171 | (I-33) | Tetramethylammonium nitrate | According to test |
| 1172 | (I-33) | Tetramethylammonium thiosulphate | According to test |
| 1173 | (I-33) | Tetramethylammonium thiocyanate | According to test |
| 1174 | (I-33) | Tetramethylammonium citrate | According to test |
| 1175 | (I-33) | Tetramethylammonium oxalate | According to test |
| 1176 | (I-33) | Tetramethylammonium formate | According to test |
| 1177 | (I-33) | Tetramethylammonium hydrogenphosphate | According to test |
| 1178 | (I-33) | Tetramethylammonium dihydrogenphosphate | According to test |
| 1179 | (I-33) | Tetraethylammonium sulphate | According to test |
| 1180 | (I-33) | Tetraethylammonium lactate | According to test |
| 1181 | (I-33) | Tetraethylammonium nitrate | According to test |
| 1182 | (I-33) | Tetraethylammonium thiosulphate | According to test |
| 1183 | (I-33) | Tetraethylammonium thiocyanate | According to test |
| 1184 | (I-33) | Tetraethylammonium citrate | According to test |
| 1185 | (I-33) | Tetraethylammonium oxalate | According to test |
| 1186 | (I-33) | Tetraethylammonium formate | According to test |
| 1187 | (I-33) | Tetraethylammonium hydrogenphosphate | According to test |
| 1188 | (I-33) | Tetraethylammonium dihydrogenphosphate | According to test |
| 1189 | (I-34) | Ammonium sulphate | According to test |
| 1190 | (I-34) | Ammonium lactate | According to test |
| 1191 | (I-34) | Ammonium nitrate | According to test |
| 1192 | (I-34) | Ammonium thiosulphate | According to test |
| 1193 | (I-34) | Ammonium thiocyanate | According to test |
| 1194 | (I-34) | Ammonium citrate | According to test |
| 1195 | (I-34) | Ammonium oxalate | According to test |
| 1196 | (I-34) | Ammonium formate | According to test |
| 1197 | (I-34) | Ammonium hydrogenphosphate | According to test |
| 1198 | (I-34) | Ammonium dihydrogenphosphate | According to test |
| 1199 | (I-34) | Ammonium carbonate | According to test |
| 1200 | (I-34) | Ammonium sulphite | According to test |
| 1201 | (I-34) | Ammonium benzoate | According to test |
| 1202 | (I-34) | Ammonium hydrogenoxalate | According to test |
| 1203 | (I-34) | Ammonium hydrogencitrate | According to test |
| 1204 | (I-34) | Ammonium acetate | According to test |
| 1205 | (I-34) | Tetramethylammonium sulphate | According to test |
| 1206 | (I-34) | Tetramethylammonium lactate | According to test |
| 1207 | (I-34) | Tetramethylammonium nitrate | According to test |
| 1208 | (I-34) | Tetramethylammonium thiosulphate | According to test |
| 1209 | (I-34) | Tetramethylammonium thiocyanate | According to test |
| 1210 | (I-34) | Tetramethylammonium citrate | According to test |
| 1211 | (I-34) | Tetramethylammonium oxalate | According to test |
| 1212 | (I-34) | Tetramethylammonium formate | According to test |
| 1213 | (I-34) | Tetramethylammonium hydrogenphosphate | According to test |
| 1214 | (I-34) | Tetramethylammonium dihydrogenphosphate | According to test |
| 1215 | (I-34) | Tetraethylammonium sulphate | According to test |
| 1216 | (I-34) | Tetraethylammonium lactate | According to test |
| 1217 | (I-34) | Tetraethylammonium nitrate | According to test |
| 1218 | (I-34) | Tetraethylammonium thiosulphate | According to test |
| 1219 | (I-34) | Tetraethylammonium thiocyanate | According to test |
| 1220 | (I-34) | Tetraethylammonium citrate | According to test |
| 1221 | (I-34) | Tetraethylammonium oxalate | According to test |
| 1222 | (I-34) | Tetraethylammonium formate | According to test |
| 1223 | (I-34) | Tetraethylammonium hydrogenphosphate | According to test |
| 1224 | (I-34) | Tetraethylammonium dihydrogenphosphate | According to test |
| 1225 | (I-35) | Ammonium sulphate | According to test |
| 1226 | (I-35) | Ammonium lactate | According to test |
| 1227 | (I-35) | Ammonium nitrate | According to test |
| 1228 | (I-35) | Ammonium thiosulphate | According to test |
| 1229 | (I-35) | Ammonium thiocyanate | According to test |
| 1230 | (I-35) | Ammonium citrate | According to test |
| 1231 | (I-35) | Ammonium oxalate | According to test |
| 1232 | (I-35) | Ammonium formate | According to test |
| 1233 | (I-35) | Ammonium hydrogenphosphate | According to test |
| 1234 | (I-35) | Ammonium dihydrogenphosphate | According to test |
| 1235 | (I-35) | Ammonium carbonate | According to test |
| 1236 | (I-35) | Ammonium sulphite | According to test |
| 1237 | (I-35) | Ammonium benzoate | According to test |
| 1238 | (I-35) | Ammonium hydrogenoxalate | According to test |
| 1239 | (I-35) | Ammonium hydrogencitrate | According to test |
| 1240 | (I-35) | Ammonium acetate | According to test |
| 1241 | (I-35) | Tetramethylammonium sulphate | According to test |
| 1242 | (I-35) | Tetramethylammonium lactate | According to test |
| 1243 | (I-35) | Tetramethylammonium nitrate | According to test |
| 1244 | (I-35) | Tetramethylammonium thiosulphate | According to test |
| 1245 | (I-35) | Tetramethylammonium thiocyanate | According to test |
| 1246 | (I-35) | Tetramethylammonium citrate | According to test |
| 1247 | (I-35) | Tetramethylammonium oxalate | According to test |
| 1248 | (I-35) | Tetramethylammonium formate | According to test |
| 1249 | (I-35) | Tetramethylammonium hydrogenphosphate | According to test |
| 1250 | (I-35) | Tetramethylammonium dihydrogenphosphate | According to test |
| 1251 | (I-35) | Tetraethylammonium sulphate | According to test |
| 1252 | (I-35) | Tetraethylammonium lactate | According to test |
| 1253 | (I-35) | Tetraethylammonium nitrate | According to test |
| 1254 | (I-35) | Tetraethylammonium thiosulphate | According to test |
| 1255 | (I-35) | Tetraethylammonium thiocyanate | According to test |
| 1256 | (I-35) | Tetraethylammonium citrate | According to test |
| 1257 | (I-35) | Tetraethylammonium oxalate | According to test |
| 1258 | (I-35) | Tetraethylammonium formate | According to test |
| 1259 | (I-35) | Tetraethylammonium hydrogenphosphate | According to test |
| 1260 | (I-35) | Tetraethylammonium dihydrogenphosphate | According to test |
| 1261 | (I-36) | Ammonium sulphate | According to test |
| 1262 | (I-36) | Ammonium lactate | According to test |
| 1263 | (I-36) | Ammonium nitrate | According to test |
| 1264 | (I-36) | Ammonium thiosulphate | According to test |
| 1265 | (I-36) | Ammonium thiocyanate | According to test |
| 1266 | (I-36) | Ammonium citrate | According to test |
| 1267 | (I-36) | Ammonium oxalate | According to test |
| 1268 | (I-36) | Ammonium formate | According to test |
| 1269 | (I-36) | Ammonium hydrogenphosphate | According to test |
| 1270 | (I-36) | Ammonium dihydrogenphosphate | According to test |
| 1271 | (I-36) | Ammonium carbonate | According to test |
| 1272 | (I-36) | Ammonium sulphite | According to test |
| 1273 | (I-36) | Ammonium benzoate | According to test |
| 1274 | (I-36) | Ammonium hydrogenoxalate | According to test |
| 1275 | (I-36) | Ammonium hydrogencitrate | According to test |
| 1276 | (I-36) | Ammonium acetate | According to test |
| 1277 | (I-36) | Tetramethylammonium sulphate | According to test |
| 1278 | (I-36) | Tetramethylammonium lactate | According to test |
| 1279 | (I-36) | Tetramethylammonium nitrate | According to test |
| 1280 | (I-36) | Tetramethylammonium thiosulphate | According to test |
| 1281 | (I-36) | Tetramethylammonium thiocyanate | According to test |
| 1282 | (I-36) | Tetramethylammonium citrate | According to test |
| 1283 | (I-36) | Tetramethylammonium oxalate | According to test |
| 1284 | (I-36) | Tetramethylammonium formate | According to test |
| 1285 | (I-36) | Tetramethylammonium hydrogenphosphate | According to test |
| 1286 | (I-36) | Tetramethylammonium dihydrogenphosphate | According to test |
| 1287 | (I-36) | Tetraethylammonium sulphate | According to test |
| 1288 | (I-36) | Tetraethylammonium lactate | According to test |
| 1289 | (I-36) | Tetraethylammonium nitrate | According to test |
| 1290 | (I-36) | Tetraethylammonium thiosulphate | According to test |
| 1291 | (I-36) | Tetraethylammonium thiocyanate | According to test |
| 1292 | (I-36) | Tetraethylammonium citrate | According to test |
| 1293 | (I-36) | Tetraethylammonium oxalate | According to test |
| 1294 | (I-36) | Tetraethylammonium formate | According to test |
| 1295 | (I-36) | Tetraethylammonium hydrogenphosphate | According to test |
| 1296 | (I-36) | Tetraethylammonium dihydrogenphosphate | According to test |
| 1297 | (I-37) | Ammonium sulphate | According to test |
| 1298 | (I-37) | Ammonium lactate | According to test |
| 1299 | (I-37) | Ammonium nitrate | According to test |
| 1300 | (I-37) | Ammonium thiosulphate | According to test |
| 1301 | (I-37) | Ammonium thiocyanate | According to test |
| 1302 | (I-37) | Ammonium citrate | According to test |
| 1303 | (I-37) | Ammonium oxalate | According to test |
| 1304 | (I-37) | Ammonium formate | According to test |
| 1305 | (I-37) | Ammonium hydrogenphosphate | According to test |
| 1306 | (I-37) | Ammonium dihydrogenphosphate | According to test |
| 1307 | (I-37) | Ammonium carbonate | According to test |
| 1308 | (I-37) | Ammonium sulphite | According to test |
| 1309 | (I-37) | Ammonium benzoate | According to test |
| 1310 | (I-37) | Ammonium hydrogenoxalate | According to test |
| 1311 | (I-37) | Ammonium hydrogencitrate | According to test |
| 1312 | (I-37) | Ammonium acetate | According to test |
| 1313 | (I-37) | Tetramethylammonium sulphate | According to test |
| 1314 | (I-37) | Tetramethylammonium lactate | According to test |
| 1315 | (I-37) | Tetramethylammonium nitrate | According to test |
| 1316 | (I-37) | Tetramethylammonium thiosulphate | According to test |
| 1317 | (I-37) | Tetramethylammonium thiocyanate | According to test |
| 1318 | (I-37) | Tetramethylammonium citrate | According to test |
| 1319 | (I-37) | Tetramethylammonium oxalate | According to test |
| 1320 | (I-37) | Tetramethylammonium formate | According to test |
| 1321 | (I-37) | Tetramethylammonium hydrogenphosphate | According to test |
| 1322 | (I-37) | Tetramethylammonium dihydrogenphosphate | According to test |
| 1323 | (I-37) | Tetraethylammonium sulphate | According to test |
| 1324 | (I-37) | Tetraethylammonium lactate | According to test |
| 1325 | (I-37) | Tetraethylammonium nitrate | According to test |
| 1326 | (I-37) | Tetraethylammonium thiosulphate | According to test |
| 1327 | (I-37) | Tetraethylammonium thiocyanate | According to test |
| 1328 | (I-37) | Tetraethylammonium citrate | According to test |
| 1329 | (I-37) | Tetraethylammonium oxalate | According to test |
| 1330 | (I-37) | Tetraethylammonium formate | According to test |
| 1331 | (I-37) | Tetraethylammonium hydrogenphosphate | According to test |
| 1332 | (I-37) | Tetraethylammonium dihydrogenphosphate | According to test |
| 1333 | (I-38) | Ammonium sulphate | According to test |
| 1334 | (I-38) | Ammonium lactate | According to test |
| 1335 | (I-38) | Ammonium nitrate | According to test |
| 1336 | (I-38) | Ammonium thiosulphate | According to test |
| 1337 | (I-38) | Ammonium thiocyanate | According to test |
| 1338 | (I-38) | Ammonium citrate | According to test |
| 1339 | (I-38) | Ammonium oxalate | According to test |
| 1340 | (I-38) | Ammonium formate | According to test |
| 1341 | (I-38) | Ammonium hydrogenphosphate | According to test |
| 1342 | (I-38) | Ammonium dihydrogenphosphate | According to test |
| 1343 | (I-38) | Ammonium carbonate | According to test |
| 1344 | (I-38) | Ammonium sulphite | According to test |
| 1345 | (I-38) | Ammonium benzoate | According to test |
| 1346 | (I-38) | Ammonium hydrogenoxalate | According to test |
| 1347 | (I-38) | Ammonium hydrogencitrate | According to test |
| 1348 | (I-38) | Ammonium acetate | According to test |
| 1349 | (I-38) | Tetramethylammonium sulphate | According to test |
| 1350 | (I-38) | Tetramethylammonium lactate | According to test |
| 1351 | (I-38) | Tetramethylammonium nitrate | According to test |
| 1352 | (I-38) | Tetramethylammonium thiosulphate | According to test |
| 1353 | (I-38) | Tetramethylammonium thiocyanate | According to test |
| 1354 | (I-38) | Tetramethylammonium citrate | According to test |
| 1355 | (I-38) | Tetramethylammonium oxalate | According to test |
| 1356 | (I-38) | Tetramethylammonium formate | According to test |
| 1357 | (I-38) | Tetramethylammonium hydrogenphosphate | According to test |
| 1358 | (I-38) | Tetramethylammonium dihydrogenphosphate | According to test |
| 1359 | (I-38) | Tetraethylammonium sulphate | According to test |
| 1360 | (I-38) | Tetraethylammonium lactate | According to test |
| 1361 | (I-38) | Tetraethylammonium nitrate | According to test |
| 1362 | (I-38) | Tetraethylammonium thiosulphate | According to test |
| 1363 | (I-38) | Tetraethylammonium thiocyanate | According to test |
| 1364 | (I-38) | Tetraethylammonium citrate | According to test |
| 1365 | (I-38) | Tetraethylammonium oxalate | According to test |
| 1366 | (I-38) | Tetraethylammonium formate | According to test |
| 1367 | (I-38) | Tetraethylammonium hydrogenphosphate | According to test |
| 1368 | (I-38) | Tetraethylammonium dihydrogenphosphate | According to test |
| 1369 | (I-39) | Ammonium sulphate | According to test |
| 1370 | (I-39) | Ammonium lactate | According to test |
| 1371 | (I-39) | Ammonium nitrate | According to test |
| 1372 | (I-39) | Ammonium thiosulphate | According to test |
| 1373 | (I-39) | Ammonium thiocyanate | According to test |
| 1374 | (I-39) | Ammonium citrate | According to test |
| 1375 | (I-39) | Ammonium oxalate | According to test |
| 1376 | (I-39) | Ammonium formate | According to test |
| 1377 | (I-39) | Ammonium hydrogenphosphate | According to test |
| 1378 | (I-39) | Ammonium dihydrogenphosphate | According to test |
| 1379 | (I-39) | Ammonium carbonate | According to test |
| 1380 | (I-39) | Ammonium sulphite | According to test |
| 1381 | (I-39) | Ammonium benzoate | According to test |
| 1382 | (I-39) | Ammonium hydrogenoxalate | According to test |
| 1383 | (I-39) | Ammonium hydrogencitrate | According to test |
| 1384 | (I-39) | Ammonium acetate | According to test |
| 1385 | (I-39) | Tetramethylammonium sulphate | According to test |
| 1386 | (I-39) | Tetramethylammonium lactate | According to test |
| 1387 | (I-39) | Tetramethylammonium nitrate | According to test |
| 1388 | (I-39) | Tetramethylammonium thiosulphate | According to test |
| 1389 | (I-39) | Tetramethylammonium thiocyanate | According to test |
| 1390 | (I-39) | Tetramethylammonium citrate | According to test |
| 1391 | (I-39) | Tetramethylammonium oxalate | According to test |
| 1392 | (I-39) | Tetramethylammonium formate | According to test |
| 1393 | (I-39) | Tetramethylammonium hydrogenphosphate | According to test |
| 1394 | (I-39) | Tetramethylammonium dihydrogenphosphate | According to test |
| 1395 | (I-39) | Tetraethylammonium sulphate | According to test |
| 1396 | (I-39) | Tetraethylammonium lactate | According to test |
| 1397 | (I-39) | Tetraethylammonium nitrate | According to test |
| 1398 | (I-39) | Tetraethylammonium thiosulphate | According to test |
| 1399 | (I-39) | Tetraethylammonium thiocyanate | According to test |
| 1400 | (I-39) | Tetraethylammonium citrate | According to test |
| 1401 | (I-39) | Tetraethylammonium oxalate | According to test |
| 1402 | (I-39) | Tetraethylammonium formate | According to test |
| 1403 | (I-39) | Tetraethylammonium hydrogenphosphate | According to test |
| 1404 | (I-39) | Tetraethylammonium dihydrogenphosphate | According to test |

Inventive crop protection compositions may also comprise further components, for example surfactants or dispersion aids or emulsifiers.

Useful nonionic surfactants or dispersion aids include all substances of this type typically useable in agrochemical formulations. Preference is given to polyethylene oxide-polypropylene oxide block copolymers polyethylene glycol ethers of linear alcohols, reaction products of fatty acids with ethylene oxide and/or propylene oxide, and also polyvinyl alcohol, polyvinylpyrrolidone, copolymers of polyvinyl alcohol and polyvinylpyrrolidone, and also copolymers of (meth)acrylic acid and (meth)acrylic esters, and also alkyl ethoxylates and alkylaryl ethoxylates, which may optionally have been phosphated and may optionally have been neutralized with bases, the examples including sorbitol ethoxylates, and also polyalkylenamine derivatives.

Useful anionic surfactants include all substances of this type which are typically used in agrochemical formulations. Preference is given to alkali metal and alkaline earth metal salts of alkylsulphonic acids or alkylarylsulphonic acids.

A further preferred group of anionic surfactants or dispersion aids is that of salts, each of which is of low solubility in vegetable oil, of polystyrenesulphonic acids, those of polyvinylsulphonic acids, those of naphthalenesulphonic acid-formaldehyde condensation products, those of condensation products of naphthalenesulphonic acid, phenol and formaldehyde, and those of lignosulphonic acid.

Useful additives which may be present in the inventive formulations include emulsifiers, foam inhibitors, preservatives, antioxidants, dyes and inert filler materials.

Preferred emulsifiers are ethoxylated nonylphenols, reaction products of alkylphenols with ethylene oxide and/or propylene oxide, ethoxylated arylalkylphenols, and also ethoxylated and propoxylated arylalkylphenols, and also sulphated or phosphated arylalkyl ethoxylates or ethoxypropoxylates, examples including sorbitan derivatives such as polyethylene oxide-sorbitan fatty acid esters and sorbitan fatty acid esters.

The examples which follow serve to illustrate the invention and should in no way be interpreted as restrictive.

### EXAMPLE 1

Aphis gossypii Test (APHIGO Spray Treatment)

Solvent: 7 parts by weight of dimethylformamide

Emulsifier: 2 parts by weight of alkylaryl polyglycol ether

To prepare a ready-to-use active ingredient formulation, 1 part by weight of active ingredient is mixed with the specified amounts of solvent and emulsifier and the concentrate is diluted with emulsifier-containing water to the desired concentration. In the case that addition of ammonium salts, penetrants, or ammonium salts and penetrants is required, they are pipetted in each case into the finished preparation solution after dilution in a concentration of 1000 ppm each.

Cotton leaves (Gossypium hirsutum) highly infested by the cotton aphid (Aphis gossypii) are sprayed with an active ingredient formulation with the desired concentration.

After the desired period, the kill rate in % is determined. 100% means that all aphids have been killed; 0% means that no aphids have been killed.

In this test, for example, the following compounds of the preparation examples exhibit good activity:

| Active | Concentration | Kill in % after 6 days | | | |
|---|---|---|---|---|---|
| ingredient | in ppm | a.i. | +AMS | +RME | +AMS + RME |
| I-1 | 0.8 | 25 | 20 | 50 | 95 |
| I-2 | 0.8 | 15 | 98 | 90 | 15 |
| I-3 | 0.8 | 0 | 15 | 35 | 90 |
| I-4 | 4 | 20 | 20 | 65 | 85 |
| I-5 | 0.8 | 0 | 5 | 15 | 85 |
| I-6 | 0.8 | 45 | 55 | 80 | 70 |
| | 0.16 | 0 | 0 | 25 | 40 |
| I-7 | 0.8 | 60 | 60 | 70 | 80 |
| I-8 | 0.8 | 20 | 30 | 60 | 75 |
| I-9 | 0.8 | 0 | 0 | 15 | 30 |
| I-10 | 4 | 65 | 99 | 85 | 99 |
| I-11 | 0.8 | 15 | 55 | 95 | 99 |
| I-12 | 4 | 55 | 80 | 85 | 75 |
| | 0.8 | 0 | 5 | 10 | 25 |
| I-13 | 4 | 80 | 65 | 75 | 75 |
| | 0.8 | 0 | 5 | 5 | 20 |
| I-14 | 0.8 | 0 | 5 | 40 | 70 |
| I-15 | 4 | 60 | 85 | 98 | 98 |
| I-16 | 4 | 80 | 95 | 98 | 90 |
| | 0.8 | 0 | 10 | 10 | 5 |
| I-17 | 0.8 | 0 | 20 | 40 | 40 |
| I-18 | 0.8 | 65 | 50 | 75 | 90 |
| I-19 | 4 | 15 | 40 | 85 | 80 |
| | 0.8 | 0 | 0 | 40 | 50 |
| I-20 | 4 | 40 | 40 | 85 | 60 |
| I-21 | 4 | 10 | 5 | 50 | 45 |
| I-22 | 4 | 60 | 70 | 55 | 65 |
| | 0.8 | 25 | 20 | 30 | 45 |
| I-23 | 0.8 | 10 | 15 | 50 | 25 |
| I-24 | 20 | 50 | 85 | 85 | 90 |
| I-25 | 4 | 65 | 60 | 75 | 100 |
| I-26 | 0.8 | 90 | 70 | 98 | 98 |
| I-28 | 20 | 55 | 90 | 95 | 95 |
| | 4 | 50 | 60 | 75 | 80 |
| I-29 | 4 | 50 | 65 | 50 | 75 |
| I-30 | 20 | 80 | 100 | 100 | 95 |
| I-31 | 0.8 | 50 | 65 | 80 | 80 |
| | 0.16 | 0 | 30 | 15 | 60 |
| I-32 | 20 | 0 | 100 | 100 | 100 |
| I-33 | 4 | 30 | 25 | 65 | 15 |
| I-34 | 100 | 15 | 20 | 40 | 45 |
| I-35 | 100 | 60 | 75 | 85 | 75 |
| I-36 | 100 | 55 | 98 | 80 | 99 |
| | 20 | 30 | 15 | 45 | 65 |
| I-37 | 20 | 55 | 45 | 40 | 65 |
| I-38 | 100 | 45 | 90 | 70 | 55 |
| I-39 | 100 | 45 | 45 | 60 | 60 |

AMS = Ammonium sulphate
RME = Rapeseed oil methyl ester (formulated for use as 500 EW)

### EXAMPLE 2

Myzus persicae Test (MYZUPE)

Solvent: 7 parts by weight of dimethylformamide

Emulsifier: 2 parts by weight of alkylaryl polyglycol ether

To prepare an appropriate active ingredient formulation, 1 part by weight of active ingredient is mixed with the given amounts of solvent and emulsifier, and the concentrate is diluted with emulsifier-containing water to the desired concentration. In the case that addition of ammonium salts, penetrants, or ammonium salts and penetrants is required, they are pippetted in each case into the finished preparation solution after dilution in a concentration of 1000 ppm each.

Pepper plants (Capsicum annuum) highly infested by the green peach aphid (Myzus persicaei) are treated by spraying with the active ingredient formulation in the desired concentration.

After the desired time, the kill rate in % is determined. 100% means that all animals have been killed; 0% means that no animals have been killed.

In this test, for example, the following compounds of the preparation examples exhibit good activity:

| Active | Concentration | Kill in % after 6 days | | | |
|---|---|---|---|---|---|
| ingredient | in ppm | a.i. | +AMS | +RME | +AMS + RME |
| I-1 | 4 | 35 | 95 | 99 | 99 |
| | 0.8 | 0 | 0 | 25 | 35 |
| I-2 | 0.8 | 0 | 50 | 98 | 30 |
| I-3 | 4 | 0 | 80 | 85 | 100 |
| I-4 | 4 | 15 | 80 | 90 | 100 |
| I-5 | 0.8 | 0 | 0 | 5 | 70 |
| I-6 | 4 | 60 | 85 | 100 | 100 |
| I-7 | 0.8 | 55 | 45 | 80 | 90 |
| I-8 | 0.8 | 40 | 50 | 95 | 95 |
| I-9 | 4 | 0 | 15 | 60 | 70 |
| I-10 | 0.8 | 0 | 0 | 90 | 99 |
| I-11 | 0.8 | 85 | 95 | 99 | 99 |
| | 0.16 | 0 | 0 | 0 | 90 |
| I-12 | 4 | 85 | 95 | 100 | 95 |
| | 0.8 | 5 | 0 | 10 | 45 |
| I-13 | 0.8 | 5 | 5 | 35 | 90 |
| I-14 | 4 | 25 | 60 | 95 | 95 |
| I-15 | 0.8 | 0 | 0 | 80 | 0 |
| I-16 | 4 | 95 | 99 | 98 | 100 |
| | 0.8 | 5 | 0 | 10 | 10 |
| I-17 | 4 | 95 | 99 | 100 | 100 |
| | 0.8 | 0 | 5 | 35 | 25 |
| I-18 | 4 | 80 | 95 | 100 | 100 |
| | 0.8 | 25 | 0 | 98 | 70 |
| I-19 | 20 | 80 | 80 | 98 | 100 |
| I-20 | 20 | 40 | 85 | 98 | 95 |
| | 4 | 15 | 35 | 85 | 55 |
| I-21 | 100 | 50 | 70 | 90 | 65 |
| I-22 | 20 | 65 | 80 | 85 | 90 |
| | 4 | 5 | 0 | 70 | 80 |
| I-23 | 0.8 | 35 | 10 | 75 | 80 |
| I-24 | 20 | 75 | 90 | 95 | 98 |
| | 4 | 15 | 20 | 85 | 75 |
| I-25 | 4 | 0 | 50 | 80 | 55 |
| I-26 | 0.8 | 65 | 55 | 100 | 95 |
| I-28 | 4 | 50 | 15 | 90 | 95 |
| I-29 | 0.8 | 0 | 0 | 30 | 50 |
| I-30 | 0.8 | 5 | 25 | 95 | 45 |
| I-31 | 0.8 | 50 | 80 | 100 | 95 |
| I-32 | 20 | 15 | 100 | 98 | 100 |
| | 4 | 0 | 60 | 70 | 80 |
| I-33 | 100 | 40 | 45 | 95 | 95 |
| I-34 | 100 | 40 | 50 | 85 | 85 |
| I-35 | 100 | 75 | 75 | 98 | 95 |
| I-36 | 20 | 40 | 25 | 85 | 85 |
| I-37 | 20 | 20 | 35 | 90 | 95 |
| I-38 | 4 | 5 | 5 | 65 | 70 |
| I-39 | 100 | 85 | 90 | 95 | 95 |
| | 20 | 20 | 25 | 80 | 30 |

AMS = Ammonium sulphate
RME = Rapeseed oil methyl ester (formulated for use as 500 EW)

1. Composition comprising
at least one active insecticidal ingredient of the formula (I) 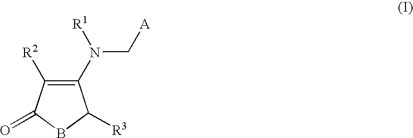
in which
A is pyrid-2-yl or pyrid-4-yl, or is pyrid-3-yl which is optionally 6-substituted by fluorine, chlorine, bromine, methyl, trifluoromethyl or trifluoromethoxy, or is pyridazin-3-yl, which is optionally 6-substituted by chlorine or methyl, or is pyrazin-3-yl or is 2-chloropyrazin-5-yl or is 1,3-thiazol-5-yl which is optionally 2-substituted by chlorine or methyl, or
A is a pyrimidyl, pyrazolyl, thiophenyl, oxazolyl, isoxazolyl, 1,2,4-oxadiazolyl, isothiazolyl, 1,2,4-triazolyl or 1,2,5-thiadiazolyl radical which is optionally substituted by fluorine, chlorine, bromine, cyano, nitro, C₁-C₄-alkyl (which is optionally substituted by fluorine and/or chlorine), C₁-C₃-alicylthio (which is optionally substituted by fluorine and/or chlorine) or C₁-C₃-alkylsulphonyl (which is optionally substituted by fluorine and/or chlorine),
or
A is a radical 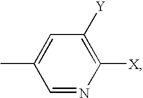
in which
X is halogen, alkyl or haloalkyl,
Y is halogen, alkyl, haloalkyl, haloalkoxy, azido or cyano,
B is oxygen, sulphur, ethylene or methylene,
R¹ is hydrogen, alkyl, haloalkyl, alkenyl, haloalkenyl, alkynyl, cycloalkyl, cycloalkylalkyl, halocycloalkyl, alkoxy or halocycloalkylalkyl,
R² is hydrogen or halogen and
R³ is hydrogen or alkyl,
with the proviso that 4-{[(6-chloropyrid-3-yl)methyl](methyl)amino}furan-2(5H)-one and 4-{[(6-chloropyrid-3-yl)methyl]amino}furan-2(5H)-one are excluded, and
at least one salt of the formula (II) 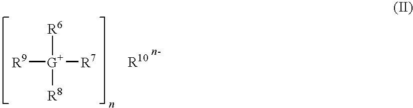
in which
G is nitrogen or phosphorus,
R⁶, R⁷, R⁸ and R⁹ are each independently hydrogen or in each case optionally substituted C₁-C₈-alkyl or mono- or polyunsaturated, optionally substituted C₂-C₈-alkylene, where the substituents may be selected from halogen, nitro and cyano,
n is 1, 2, 3 or 4 and
R¹⁰ is an inorganic or organic anion.

2. Composition according to claim 1, characterized in that the active ingredient content is between 0.5 and 50% by weight.

3. Composition according to claim 1 or 2, characterized in that G is nitrogen.

4. Composition according to any one of claims 1 to 3, characterized in that R¹⁰ is hydrogencarbonate, tetrafluoroborate, fluoride, bromide, iodide, chloride, monohydrogenphosphate, dihydrogenphosphate, hydrogensulphate, tartrate, sulphate, nitrate, thiosulphate, thiocyanate, formate, lactate, acetate, propionate, butyrate, pentanoate, citrate, oxalate, carbonate, pentaborate, sulphite, benzoate, hydrogenoxalate, hydrogencitrate, methylsulphate or tetrafluoroborate.

5. Composition according to claim 4, characterized in that R¹⁰ is lactate, sulphate, nitrate, thiosulphate, thiocyanate, citrate, oxalate or formate.

6. Composition according to claim 5, characterized in that R¹⁰ is sulphate.

7. Composition according to claim 6, characterized in that the salt of the formula (II) is ammonium sulphate.

8. Composition according to any one of claims 1 to 7, characterized in that it comprises at least one penetrant.

9. Composition according to claim 8, characterized in that the penetrant comprises a fatty alcohol alkoxylate of the formula (III)
R—O-(-AO)ᵥ—R′ (III)
in which
R is straight-chain or branched alkyl having from 4 to 20 carbon atoms,
R′ is hydrogen, methyl, ethyl, n-propyl, i-propyl, n-butyl, i-butyl, t-butyl, n-pentyl or n-hexyl,
AO is an ethylene oxide radical, a propylene oxide radical, a butylene oxide radical, or mixtures of ethylene oxide and propylene oxide radicals or butylene oxide radicals, and
v is 2 to 30,
or a mineral or vegetable oil or the ester of a mineral or vegetable oil.

10. Composition according to claim 8, characterized in that the penetrant is an ester of a vegetable oil.

11. Composition according to claim 8, characterized in that the penetrant is rapeseed oil methyl ester.

12. Composition according to any one of claims 8 to 11, characterized in that the content of penetrant is 1 to 95% by weight.

13. Process for controlling harmful insects, characterized in that a composition according to one or more of claims 1 to 12 is applied to insects or their habitat undiluted or diluted in such an amount that an effective amount of the active insecticidal ingredients present acts on the insects or their habitat.

14. Process for enhancing the action of crop protection compositions comprising an active ingredient of the formula (I) according to claim 1, characterized in that the ready-to-used composition (spray liquor) is prepared using a salt of the formula (II) according to claim 1.

15. Process according to claim 13 or 14, characterized in that the spray liquor is prepared using a penetrant.

16. Process according to any one of claims 13 to 15, characterized in that the salt of the formula (II) is present in the spray liquor in an end concentration of 0.5 to 80 mmol/l.

17. Process according to claim 15, characterized in that the penetrant is present in the spray liquor in an end concentration of 0.1 to 10 g/l.

18. Process according to claim 17, characterized in that the penetrant is present in an end concentration of 0.1 to 10 g/l and the salt of the formula (II) in an end concentration of 0.5 to 80 mmol/l.

19. Use of a salt of the formula (II) according to claim 1 for enhancing the action of a crop protection composition comprising an active ingredient of the formula (I) according to claim 1, characterized in that the salt is used in the preparation of a ready-to-use crop protection composition (spray liquor).

20. Use according to claim 19, characterized in that the salt of the formula (II) is present in the ready-to-use crop protection composition in a concentration of 0.5 to 80 mmol/l.

21. Use according to claim 19 or 20, characterized in that the salt is used in the preparation of a ready-to-use crop protection composition (spray liquor) which further comprises a penetrant.
